(19) United States
(12) Patent Application Publication
(10) Pub. No.: US 2007/0076744 A1
(43) Pub. Date: Apr. 5, 2007

(54) Communications System

(75) Inventor: Masaharu Tamatsu, Tokyo (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: ANNEX SYSTEMS INCORPORATED, Tokyo (JP)

(21) Appl. No.: 11/535,945

(22) Filed: Sep. 27, 2006

(30) Foreign Application Priority Data
Mar. 29, 2004 (JP) JP2004-094628
Dec. 20, 2004 (JP) JP2004-368123
Mar. 25, 2005 (WO) PCT/JP05/05484

(51) Int. Cl. H04L 12/413

(52) U.S. Cl. 370/445

(57) ABSTRACT

Problem: Communications networks comprising a multitude of nodes suffer frequent transmission collisions, the performance of their transmission paths goes unavailed, and delays occur in transmission. The invention provides a communications system capable of high-speed transmissions without collisions. Solution: A rhythm node is provided on the communications network, and upstream transmissions are performed subsequent to receipt by individual dominant nodes of a transmission instigation message multicast by the rhythm node and after a predetermined standby time. For downstream transmissions, the rhythm node allocates downstream transmission permission to a tonic node.

### FIELD OF THE INVENTION

The invention relates to transmission protocols, providing high-speed transmissions between nodes.

### DESCRIPTION OF RELATED ART

Conventional transmission protocols include the BSC and HDLC protocols formerly used primarily with mainframe computers and the TCP/IP protocols that have recently become mainstream on the Internet. Collision-detection transmission schemes employing TCP/IP are prevalent in a range of communications, including local-area and wide-area networks; due to the ease with which transmission collisions occur, however, they fail to take full advantage of the performance of these transmission paths. This tendency grows particularly acute when communications begin to grow congested, and only one in several tens of actual transmission capacity may be achieved. One aspect of such systems is that their capacity falls off when it is most needed.

When implemented in configurations of clients and servers, BSC and HDLC systems employ polling with control signals to avert transmission collision. As shown in FIG. 1, a node 0 successively polls each other node (1, 2, 3 and 4), and when a node polled has data to transmit, it transmits an ACK to the server to indicate that it has data to transmit. Node 1 has data to transmit and so sends an ACK to the server. Node 2 has no data to transmit and so replies NACK to the server. The server next polls node 3. In FIG. 1, node 3 is sending an ACK to the server that it has data to transmit. Further operations are omitted.

TCP/IP, on the other hand, is characterized by individual nodes transmitting data freely. Where transmissions are performed with TCP/IP, a LAN is commonly used for transmissions within some defined area. On a LAN there is no directionality on transmission paths, and electrical signals carrying data travel in all directions on the LAN. Data addressed to a specific node is commonly transmitted to other nodes on the transmission path. That this data is not processed by non-destination nodes is because data transmitted carries its destination and nodes ignore data that is not addressed to them. This is effected by transmission mechanisms. Multicasting is also employed for such transmissions to specific nodes. Multicasting allows such transmissions as addressed to all nodes and addressed to each node belonging to a group made up of some number of nodes. As the transmitting node need make but a single transmission rather than transmitting the data to each destination node, the load on the transmitting node and the load on the transmission path may be alleviated. This design allows transmissions between nodes to be performed freely. As shown in FIG. 2, however, data flows bidirectionally on a LAN when transmitted from some given node. In FIG. 2, data S20 and data S21 are traveling to the left and to the right in the drawing, respectively. Although node 4 can recognize that the data (S21) from node 3 is traveling on the LAN, node 5 is unable to detect its presence on the LAN at the point shown in FIG. 2 due to electrical delay. Therefore, data will collide with the data S21 if transmitted from node 5. Because both sets of data will be destroyed if a collision occurs, each node will retransmit the destroyed data. Because performing the retransmission immediately would result in another collision, retransmission is performed after waiting an appropriate interval of time in order to lower the probability of collision. When the volume of LAN transmissions grows, however, the probability of collision grows, with the result that the capacity that may be achieved is lower the actual capacity of the LAN.

Another transmission method is token ring. This entails connecting nodes along transmission paths in the form of a ring. Nodes may transmit only when they capture an transmission permission packet called a token. This gives a low ceiling on transmission speeds, and constitutes a vulnerability in that when one of the nodes that make up a ring fails, the entire communications network shuts down.

Although the foregoing discussion has addressed wired network communications, neither have wireless systems offered effective means of averting collisions.

### DISCLOSURE OF THE INVENTION

### Problems Solved by the Invention

As discussed above, even if a communications network (for example, a LAN) is speeded up, protocols and means for drawing on its full capacity are inadequate, and the capacity of such networks is not availed. In a typical office environment, the preponderance of client communications are with a server, and such transmissions are susceptible to collisions because the volume of communications readily expands and transmissions are bidirectional.

While it is logically possible to perform transmissions by determining the time slot occupied by each node if nodes are fully synchronized time-wise, because the clocks that servers and personal computers are equipped with are accurate only to within one or two seconds in 24 hours, in fact the machines fall out of temporal synchronization while in operation. The problem solved by the invention is to enable protocols and means of achieving high-speed transmissions on LANs and other communications networks without engendering collisions to support a variety of network topologies.

### Means for Solving the Problem

(1) An embodiment of the present invention is a communications system comprising a rhythm node that transmits transmission instigation messages, dominant nodes that transmit data upon receipt of a transmission instigation message, and transmission paths, along which the rhythm node transmits transmission instigation messages and the individual dominant nodes, upon receiving a transmission instigation message, transmit data in upstream transmissions after their individual standby times.

(2) An embodiment of the present invention is the communications system of (1) above having a rhythm node that multicasts transmission instigation messages.

(3) An embodiment of the present invention is the communications system of (1) above having tonic nodes that perform downstream transmissions to dominant nodes on allocation of downstream transmission permission from the rhythm node.

(4) An embodiment of the present invention is the communications system of (1) above in which dominant nodes have individual transmission sequence numbers and, upon receiving transmission instigation messages from the rhythm node, transmit data signals to a tonic node after the standby time specified by their individual transmission sequence numbers.

(5) An embodiment of the present invention is the communications system of (1) above having an upstream transmission permission allocation data storage region.

(6) An embodiment of the present invention is the communications system of (1) above comprising an upstream transmission permission allocation data storage region in which the rhythm node is capable of writing dominant-node identification information and transmission sequence numbers to an transmission permission allocation data storage region and of editing that data.

(7) An embodiment of the present invention is the communications system of (1) above having tonic nodes that perform downstream transmissions to dominant nodes on allocation of downstream transmission permission from the rhythm node and having a downstream transmission permission allocation data storage region.

(8) An embodiment of the present invention is the communications system of (1) above comprising tonic nodes that perform downstream transmissions to dominant nodes on allocation of downstream transmission permission from the rhythm node and a downstream transmission permission allocation data storage region, in which the rhythm node is capable of writing tonic-node identification information and downstream transmission permission allocation states to an transmission permission allocation data storage region and of editing that data.

(9) An embodiment of the present invention is the communications system of (1) above in which upstream transmission permission is allocated to dominant nodes by the rhythm node assigning transmission sequence numbers to dominant nodes.

(10) An embodiment of the present invention is the communications system of (1) above in which a tonic node performs transmissions to dominant nodes by means of the assignment to it of transmission permission by the rhythm node.

(11) An embodiment of the present invention is the communications system of (1) above in which the rhythm node transmits transmission instigation messages to the dominant nodes and directs individual dominant nodes to transmit, upon receiving transmission instigation messages, data to a tonic node after their individual standby times.

(12) An embodiment of the present invention is the communications system of (1) above constituting a final communications apparatus situated along transmission paths connecting a tonic node and the dominant nodes and comprising the functionality of a tonic node and a dominant node.

(13) An embodiment of the present invention is the communications system of (1) above constituting an intermediate communications apparatus situated along transmission paths connecting a tonic node and the dominant nodes, and comprising a rhythm node.

(14) An embodiment of the present invention is the communications system of (1) above constituting an intermediate communications apparatus situated along transmission paths connecting tonic nodes and the dominant nodes, and comprising an outgoing-transmission storage apparatus that collects data signals transmitted from dominant nodes by means of instigating signals from the rhythm node and collects data signals transmitted by the tonic nodes by means of transmission permission allocated by the rhythm node.

(15) An embodiment of the present invention is the communication systems of (1) above constituting an intermediate communications apparatus situated along transmission paths connecting tonic nodes and the dominant nodes, and comprising an incoming-transmission storage apparatus that transmits to a tonic node data signals collected by means of transmissions of instigating signals from the rhythm node and transmits to dominant nodes data signals collected by means of allocation of transmission permission by the rhythm node.

(16) An embodiment of the present invention is the communications systems of (1) above constituting an intermediate communications apparatus comprising a rhythm node situated along transmission paths connecting tonic nodes and the dominant nodes.

(17) An embodiment of the present invention is the communications system of (1) above in which transmissions are performed by dividing data signals among slots.

(18) An embodiment of the present invention is the communications system of (1) above in which a tonic node is a base station, dominant nodes are communications devices and the base station and communications devices communicate by wireless means.

### Effect of the Invention

The present invention permits the suppression of transmission collisions and the greatest possible utilization of the maximum capacity of a communications system.

### BRIEF DESCRIPTION OF THE DRAWINGS

FIG. 1 illustrates transmission using polling.

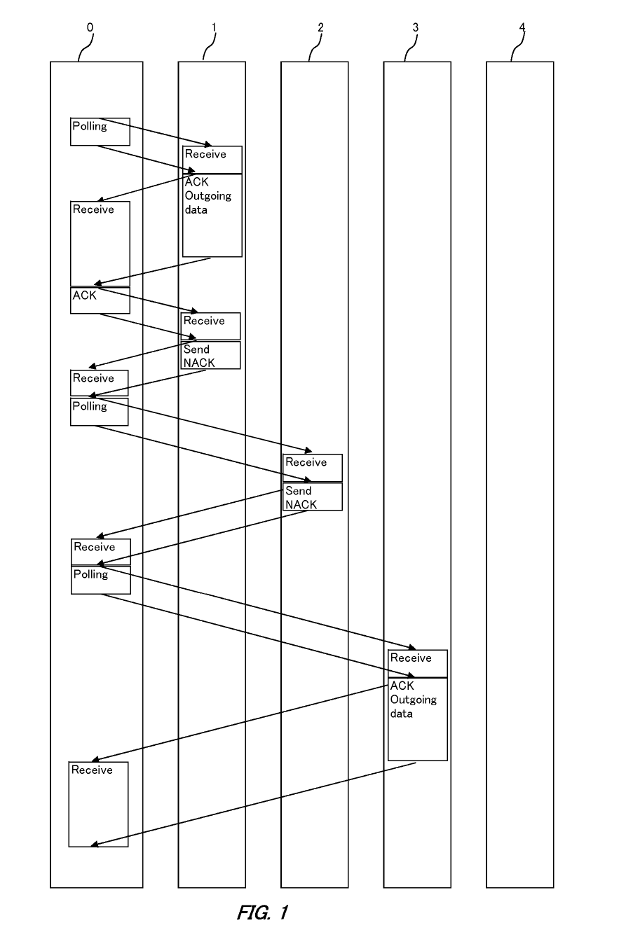

FIG. 2 illustrates transmissions on a generic LAN.

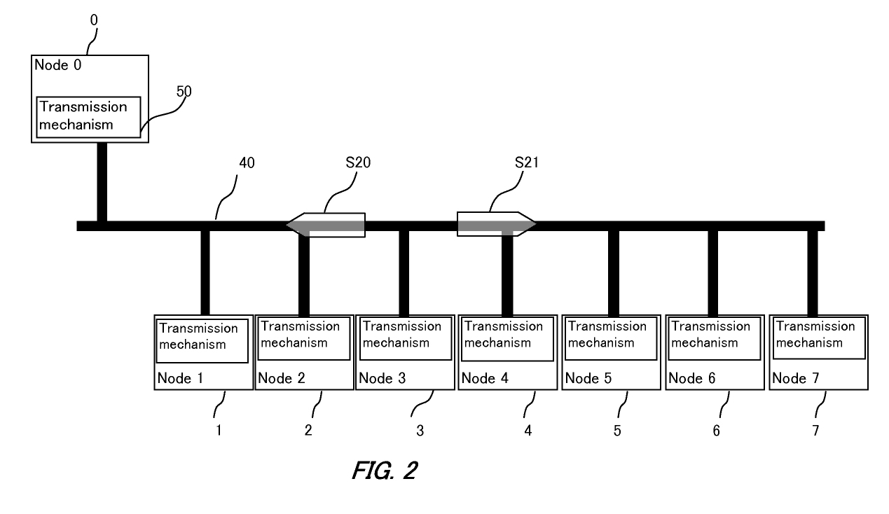

FIG. 3 illustrates bidirectional transmission enabled with an intermediate communications apparatus and the lack of need for a tonic node.

FIG. 4 illustrates a communications system configured with cascade connections.

FIG. 5 is a time chart employing transmission instigation messages multicast in a communications system configured with cascade connections.

FIG. 6 is a time chart employing transmission instigation messages multicast in a communications system configured with cascade connections in which upstream transmissions in communications between a dominant node and a final communications apparatus are transmitted to another dominant node as downstream transmissions.

FIG. 7 illustrates an example of a communications system configured with cascade connections in which all transmission paths are divided into upstream paths and downstream paths.

FIG. 8 illustrates the functionality of a final communications apparatus in an example of a communications system configured with cascade connections in which all transmission paths are divided into upstream paths and downstream paths.

FIG. 9 is a time chart in which empty packets are used by other dominant nodes in an example of a communications system configured with cascade connections.

FIG. 10 illustrates an example of a communications system configured with cascade connections in which a multilevel rhythm node is used.

FIG. 11 provides the format of a transmission instigation message where the number of transmission packets differs with each dominant node, in which the format includes the standby times of the dominant nodes.

FIG. 12 provides the format of a transmission instigation message where the number of transmission packets differs with each dominant node, in which the format does not include the standby times of the dominant nodes.

FIG. 13 illustrates an example of a communications system configured with cascade connections in which a portion of the transmission paths are divided into upstream paths and downstream paths and are not divided into upstream paths and downstream paths between a final communications apparatus and the dominant nodes.

FIG. 14 illustrates an example of a communications system configured with cascade connections in which a portion of the transmission paths are divided into upstream paths and downstream paths and are not divided into upstream paths and downstream paths between a final communications apparatus and the dominant nodes, and the final communications apparatus has the functionality of a tonic node and a dominant node.

FIG. 15 is a time chart in which transmission instigation messages are transmitted serially rather than multicast.

FIG. 16 illustrates an example of a communications system configured with cascade connections in which a portion of the transmission paths are divided into upstream paths and downstream paths and are not divided into upstream paths and downstream paths between a final communications apparatus and the dominant nodes, and in which a hub is used.

FIG. 17 illustrates an example of a communications system configured with cascade connections in which a portion of the transmission paths are divided into upstream paths and downstream paths and are not divided into upstream paths and downstream paths between a final communications apparatus and the dominant nodes, and in which a multilevel rhythm node and a hub are used.

FIG. 18 illustrates an example of a communications system configured with cascade connections in which multiple tonic nodes exist and the tonic nodes are connected to an intermediate communications apparatus in a bus topology.

FIG. 19 illustrates an example of a communications system configured with cascade connections in which multiple tonic nodes exist and the tonic nodes are connected to an intermediate communications apparatus in a star topology.

FIG. 20 illustrates an example of an outgoing-transmission storage apparatus incorporated into an intermediate communications apparatus.

FIG. 21 illustrates an example of a communications system configured with cascade connections in which multiple tonic nodes exist, the tonic nodes are connected to an intermediate communications apparatus in a star topology and the tonic nodes are connected to each other by transmission paths.

FIG. 22 illustrates an example of the use of multiple intermediate communications apparatuses to diminish the concentration of transmissions.

FIG. 23 an example of a communications system configured with cascade connections in which the communications system extends over multiple floors.

FIG. 24 depicts outgoing-transmission storage apparatuses in an example of a communications system configured with cascade connections in which the communications system extends over multiple buildings.

FIG. 25 depicts incoming-transmission storage apparatuses in an example of a communications system configured with cascade connections in which the communications system extends over multiple buildings.

FIG. 26 illustrates an example of a communications system configured with cascade connections in which multiple tonic nodes exist and the tonic nodes are connected to multiple intermediate communications apparatuses in a star topology.

FIG. 27 illustrates a bus-topology communications system employing two-way branching for downstream transmissions.

FIG. 28 illustrates a bus-topology communications system employing one-way branching for downstream transmissions.

FIG. 29 is a time chart of transmission instigation messages multicast in a bus-topology communications system.

FIG. 30 is a time chart of transmission instigation messages multicast in a bus-topology communications system where other nodes use empty messages.

FIG. 31 illustrates a configuration for time-chart multicasting of transmission instigation messages in a bus-topology communications system where other nodes use empty messages.

FIG. 32 is a time chart of collision aversion in a bus-topology communications system by means of multicasting transmission instigation messages and using appropriate standby times for individual dominant nodes.

FIG. 33 illustrates a communications system in a ring topology.

FIG. 34 is a time chart of dynamically assigned upstream transmission permission.

FIG. 35 describes an upstream transmission permission request message.

FIG. 36 describes an upstream transmission permission request message where upstream transmission permission is assigned dynamically.

FIG. 37 is a time chart of upstream transmission permission requests and upstream transmission permission cession where upstream transmission permission is assigned dynamically.

FIG. 38 illustrates transition of transmission sequence numbers where the number of dominant nodes having upstream transmission permission is variable.

FIG. 39 is a schematic drawing of a base station and communications devices in a wireless system.

FIG. 40 is a schematic drawing depicting distances between a base station and transmission devices in a wireless system.

FIG. 41 is a time chart of wireless communications.

FIG. 42 is a time chart where the distance between a rhythm node and dominant nodes in a wireless system is great.

FIG. 43 illustrates a multilevel communications unit.

### REFERENCE NUMERALS IN DRAWINGS

0, 00, 01, 02, 03, 04 . . . Tonic nodes
1, 2, 3, 4, 5, 6, 7, 8, 9, 10, 11, 12 . . . Dominant nodes
20, 21, 22, 23, 24 . . . Rhythm nodes
301, 302 . . . Branch transmission paths
311, 312, 313 . . . Branch transmission paths
321, 322 . . . Branch transmission paths
331, 332 . . . Branch transmission paths
41, 42, 43 . . . Transmission paths
50, 54, 55, 57 . . . Intermediate communications apparatuses
51, 52, 53, 56 . . . Final communications apparatuses
541, 551 . . . Outgoing-transmission storage apparatuses
542, 552 . . . Incoming-transmission storage apparatuses
61, 62, 63, 64, 65, 66 . . . Transmission paths
71, 72, 73, 74, 75, 76 . . . Transmission paths
610, 611, 612, 613, 614 . . . Transmission paths
710, 711, 712, 713, 714 . . . Transmission paths
621, 622, 623, 624 . . . Transmission paths
631, 632, 633 . . . Transmission paths
641, 642, 643, 644 . . . Transmission paths
80, 81, 82 . . . Hubs
89 . . . Router
91, 92, 93 . . . Transmission mechanisms
100 . . . Communications unit ε
101 . . . Communications unit ζ
S1 . . . Transmission instigation
S2, S3, S4, S5 . . . Upstream transmissions from a dominant node
S20, S21 . . . Transmission messages
S30, S31, S32, S33 . . . Transmissions to an outgoing-transmission storage apparatus
S34, S35, S36, S37 . . . Transmissions to an outgoing-transmission storage apparatus
S40, S41, S42, S43 . . . Transmissions from an incoming-transmission storage apparatus
400 . . . Window of transmission instigation transmission

### PREFERRED EMBODIMENTS OF THE INVENTION

As communications systems and communications networks are typified by transmissions between clients and servers, this specification concerns itself primarily with such networks. However, it is not especially restricted to such communications and is applicable to data transmissions in general, including internal communications in a computer system, for example, or communications internal to a computing device equipped with multiple central processing units. The present invention is further applicable to wireless communications as well as wired communications. In addition to metallic cable, fiber cable and other avenues of wired communications, transmission paths include the frequency bands employed for transmission in wireless communications.

Collisions in transmissions may be averted by performing transmissions to individual nodes rhythmically. One method of performing operations rhythmically is to synchronize all nodes on the network time-wise and then perform transmissions according to a predetermined temporal rhythm. However, clock accuracy makes it problematic, as discussed in “Problems Solved by the Invention” to achieve complete synchronization time-wise. Temporal synchronization is possible, however, if only for short periods of time, even with the accuracy of the clocks that personal computers are equipped with. If a synchronization signal is multicast from a specific node and, upon receiving the synchronization signal, nodes immediately perform transmissions in the order in which they receive that synchronization signal, it becomes possible to prevent collisions and to increase the density of transmissions. Such synchronization signals are herein termed transmission instigation messages. The nodes that transmit these transmission instigation messages are termed rhythm nodes.

A transmission path having a speed of 10 Gbps is capable of transmitting 10 bits per nanosecond (ns), requiring 0.8 ns for the transmission of one byte. The time required to transmit 256 bytes is then 204.8 ns. Working with 210 ns for the margin, it would take 210 microseconds (μs) for 1,000 dominant nodes to transmit one 256-byte message each. Given a clock deviation of one in 100,000, the deviation from 210 μs will be 2.1 ns. Given a somewhat slower LAN speed of 100 Mbps, it would take 21 milliseconds (ms) to send one 256-byte message from each of the dominant nodes. A clock deviation of one in 100,000 gives a deviation of 210 ns per 21 ms. Clocks may deviate, but only to this extent, and network transmission efficiency does not constitute a problem even with this amount of standby time. However, the clock deviation that accumulates over a period of one hour is 36 ms and does not allow for efficient communications.

In a typical office environment, communications between clients and servers, or communications similar thereto, account for the majority of transmissions, and there are few client-client transmissions. The volume of transmissions originating with servers is typically larger the volume of transmissions originating with clients. Further, while many clients exist on a network, the number of servers is limited. In order to perform such communications effectively and without collisions, the network is provided rhythm node functionality or equipment. In addition to the term rhythm node, this specification also employs the terms tonic node and dominant node. A rhythm node transmits transmission instigation messages to dominant nodes. A rhythm node also allocates downstream transmission permission to tonic nodes and causes tonic nodes to perform downstream transmissions. Data transmissions from a tonic node are termed downstream transmissions. Individual dominant nodes each have a transmission sequence number, and the standby time (the predetermined standby time) of each dominant node is determined on the basis of such information as that transmission sequence number, the transmission speed of the transmission path and the length of the transmission path. Upon receiving a transmission instigation message from a rhythm node, a dominant node performs a data transmission after the predetermined standby time has passed. Data transmissions from dominant nodes are termed upstream transmissions. The predetermined standby time is discussed in further detail below.

A rhythm node transmits transmission instigation messages so that transmissions may be performed smoothly. Upon receiving a transmission instigation message, a dominant node counts the time and transmits upstream transmission messages after the predetermined standby time. Each dominant node has a transmission sequence number on the network, and its predetermined standby time is defined by that transmission sequence number. Where transmission paths are not divided into upstream paths and downstream paths, the rhythm node allocates downstream transmission permission to a tonic node after one cycle of upstream transmissions from the dominant nodes, and a tonic node then performs downstream transmissions. When the downstream transmissions have completed, the rhythm node again sends transmission instigation messages. Upon receiving a new transmission instigation message, a dominant node again counts the time. The counting of time in a dominant node is thus performed within a definite period of time after the reception of a transmission instigation message. Because this period of time is a short one, there is little clock deviation and synchronization may be achieved.

In other words, a dominant node is a node that performs upstream transmissions upon receiving a transmission instigation message from a rhythm node. A transmission instigation message is a signal, contains information identifying it as a transmission instigation message and triggers a dominant node to perform an upstream transmission. A tonic node is a node that obtains allocation of downstream transmission permission from the rhythm node and performs downstream transmissions. Tonic nodes would typically include mail servers, application processing servers, print servers, DNS servers, and routers installed at an Internet gateway. Another example of dominant nodes and a tonic node would be a plurality of sensors and a device that concentrates their data. In this case, the sensors correspond to dominant nodes, and the concentrating device serves as a tonic node. In a configuration where a plurality of CPUs are used to perform calculations and the results loaded into a central system, the multiple CPUs would be dominant nodes and the central system a tonic node. The use of multicasting for transmission instigation messages is advantageous. Where transmission instigation messages are multicast, either the tonic node should ignore the multicasting or, when transmitting transmission instigation messages, the rhythm node should not pass them on the transmission path to which the tonic node is connected. While dominant nodes are typically application processing or mail clients, they may also be sensors or CPUs, as set forth above. The transmission of transmission instigation messages is performed each upstream transmission cycle.

Examples of upstream transmission include the transmission to a server of a request input at a terminal and checking whether mail has arrived. Examples of downstream transmission include the transmission of the request processing results to the terminal and the transmission of mail that has arrived. In a typical office environment, both tonic nodes and dominant nodes exist plurally. Downstream transmissions from tonic nodes and upstream transmissions from dominant nodes are conventionally transmitted at liberty, resulting in collisions, depending on the timing. Another problem has been that the probability of collision rises when communications become congested. Tonic nodes and dominant nodes have relativistic relationships, and a node that is a dominant node with respect to a tonic node may be a tonic node with respect to another node. Examples of such are recited below.

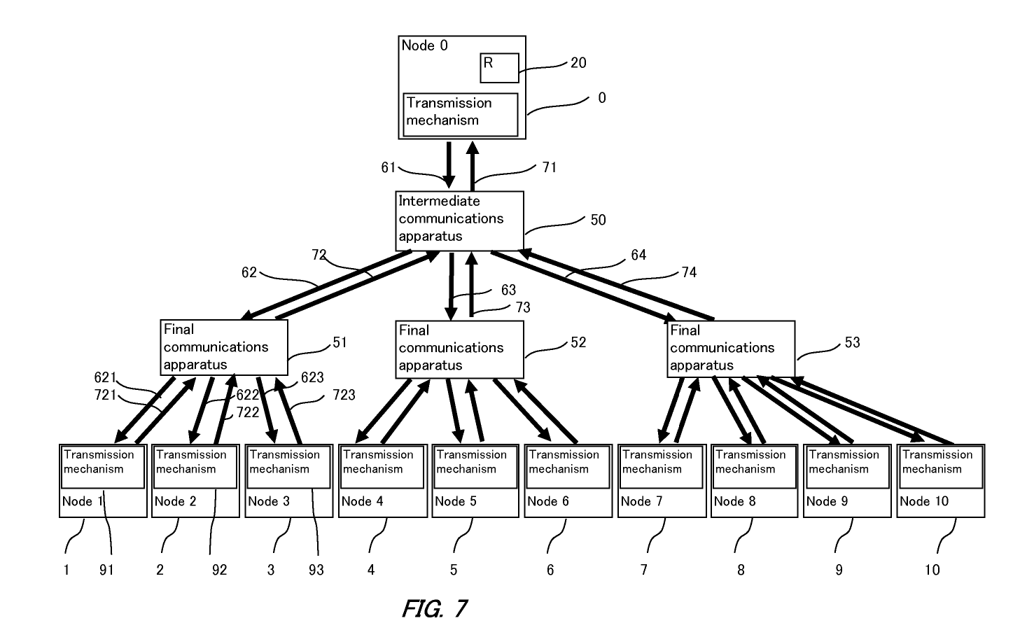

A rhythm node may be either functionality or a stand-alone node. In other words, a rhythm node may be embedded within any given node or may be a specific stand-alone machine. In a communications network diagram (FIG. 7, for example), the rhythm node must be situated in a location from which it can multicast to the requisite dominant nodes. Utilization of a rhythm node thus allows coordination of an entire network and harmonization of transmissions.

Cascade Connection

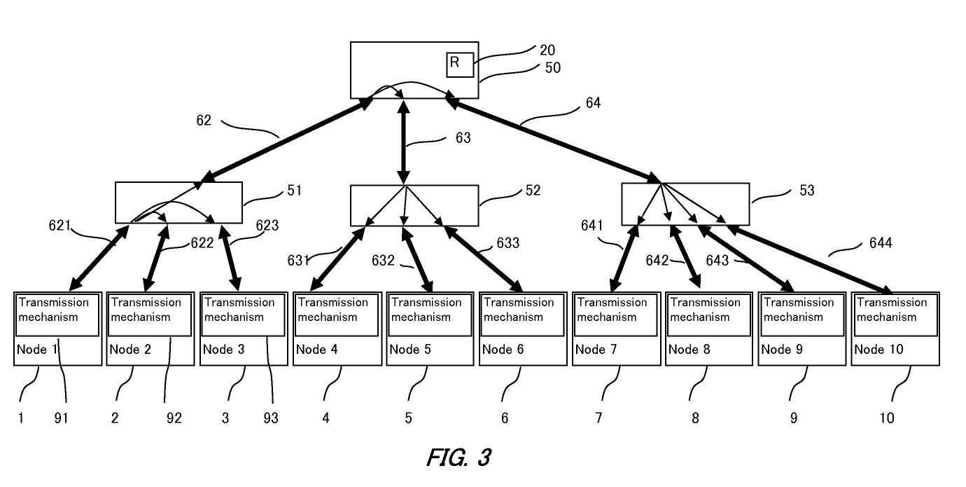

The recitation first addresses the utilization, in cascade connection, of transmission paths that are not divided into upstream and downstream transmission paths. FIG. 3 depicts a configuration common among small LANs. Here, the communications apparatuses 50, 51, 52 and 53 have functionality equivalent to routinely used hubs. In other words, input entering along one transmission path also passes along other transmission paths. The difference with conventional communications systems is that a rhythm node 20 is embedded in the communications apparatus 50. Nodes 1 through 10 are dominant nodes. To simplify, transmission path lengths are taken to be equal. The transmission sequence numbers are 1 for node 1, 2 for node 2 . . . 10 for node 10. Here, rhythm node 20 multicasts transmission instigation messages. The transmission instigation messages thus arrive simultaneously at the dominant nodes 1, 2, 3 . . . 10. Here, dominant node 1 performs upstream transmission immediately. Dominant node 2 waits for the transmission of dominant node 1 to complete and then performs upstream transmission. Dominant node 3 waits for the transmission of dominant node 2 to complete and then performs upstream transmission. Subsequent upstream transmissions are performed in like fashion. Because upstream transmissions are performed thusly, transmission collisions do not occur. The times that individual nodes wait to perform upstream transmissions are predetermined standby times. In the foregoing instance, nodes 1 through 10 function as dominant nodes.

In FIG. 3 nodes 1 through 10 are depicted as dominant nodes, but this network may also function with node 1 as a tonic node and nodes 2 through 10 as dominant nodes. Transmission path lengths are taken to be equal. The transmission sequence numbers are 1 for node 2, 2 for node 3 . . . 9 for node 10. A rhythm node 20 multicasts transmission instigation messages. Since node 1 is a tonic node, it ignores the transmission instigation messages. Node 2 performs upstream transmission immediately. Node 3 performs upstream transmission after the predetermined standby time. Upstream transmissions are thus in sequence through node 10. When the upstream transmission of node 10 has completed, the rhythm node 20 allocates downstream transmission permission to node 1. Node 1 performs downstream transmission. The volume of this downstream transmission need not be restricted to a single packet, but may be of a reasonable number of packets.

The configuration of FIG. 3 is a simple one. Because a signal may travel along any transmission path, however, when node 4 performs upstream transmission after node 3, for example, upstream transmission is performed after the signals have traversed the lengths of transmission paths 62, 63 and 631, and the predetermined standby time increases by that much. Conversely, a configuration may be simplified by lengthening prescribed standby times. In FIG. 3 the rhythm node 20 is depicted as embedded in a communications apparatus 50, but it may be embedded in communications apparatus 51, 52 or 53, or it may be embedded in any one of nodes 1, 2, 3 . . . 10.

Unless the rhythm node knows how the tonic nodes and dominant nodes are present in its network, it is unable to allocate upstream transmission permission or allocate downstream transmission permission. One solution is to register this information with the rhythm node beforehand. This permits dominant nodes to be allocated fixed transmission sequence numbers. Another solution is for the rhythm node to recognize dominant nodes each time they operate. Tonic nodes must be pre-registered with the rhythm node. The rhythm node allocates downstream transmission permission to tonic nodes on the basis of this registered information.

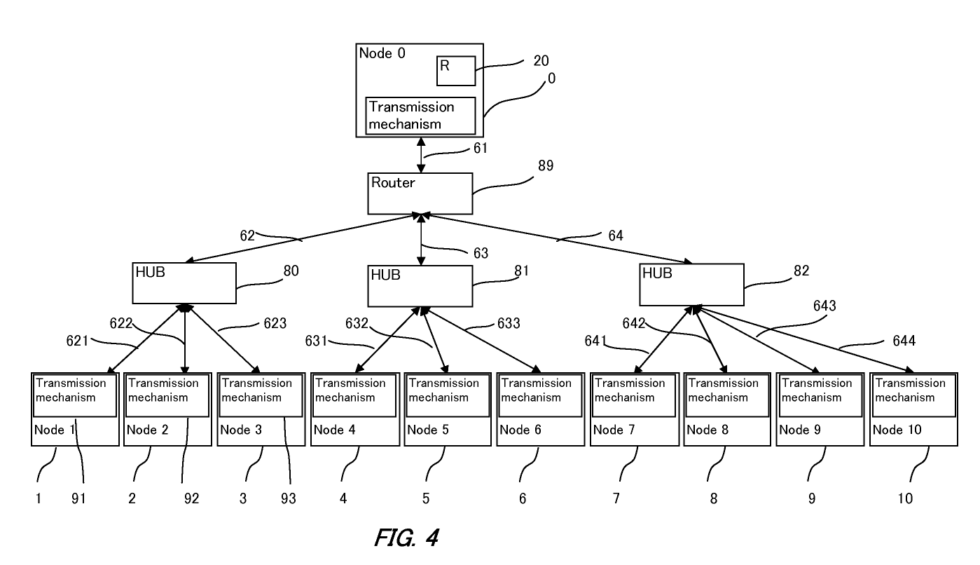

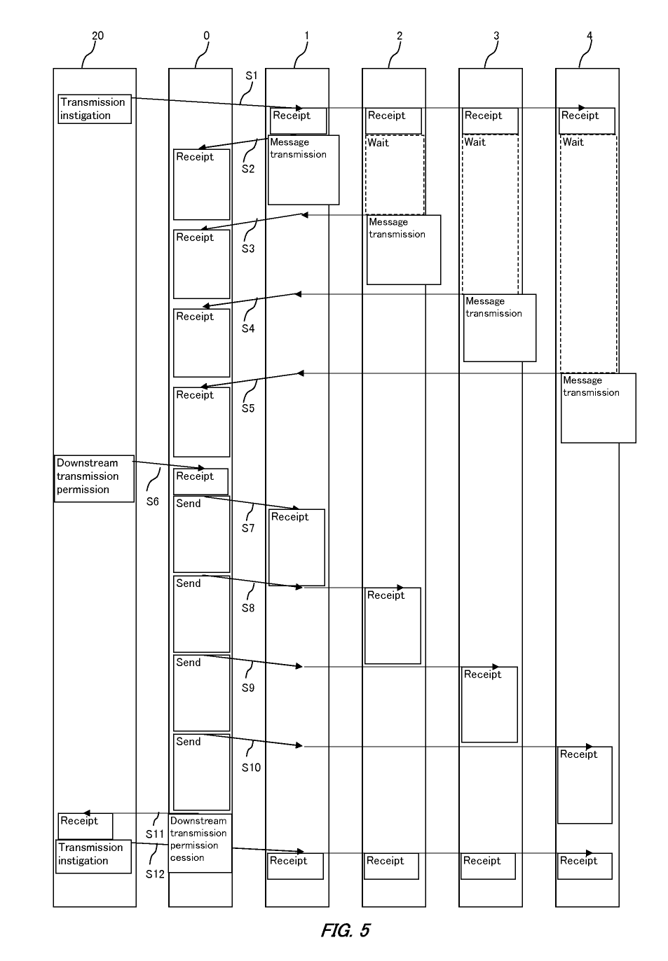

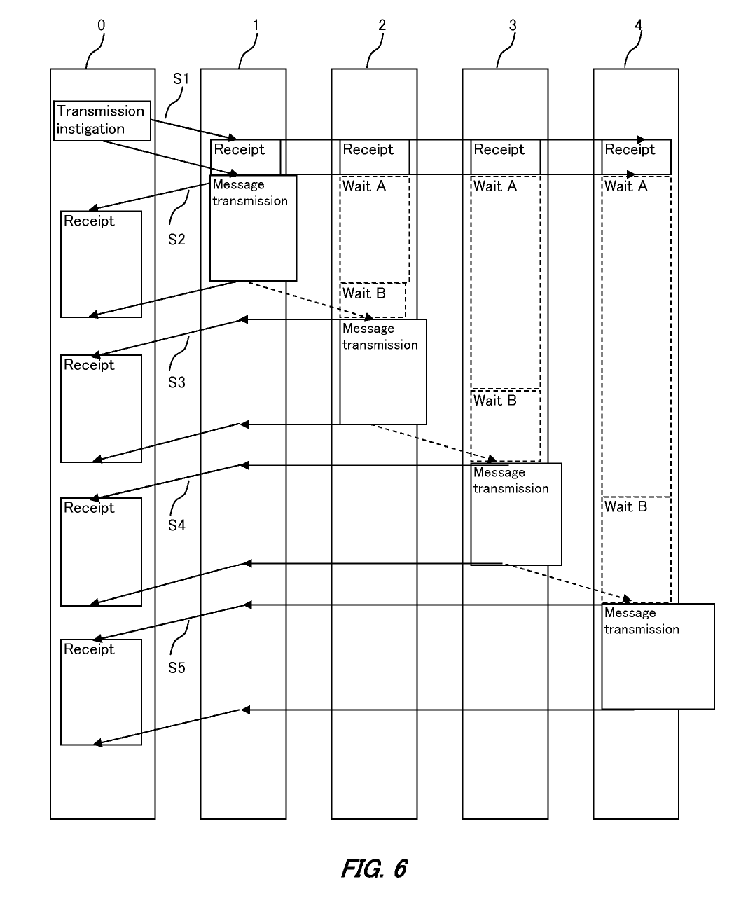

FIG. 4 depicts a network utilizing hubs and a router 89, commonly in use at present. Here, node 0 is a tonic node and nodes 1 through 10 are dominant nodes. 80, 81 and 82 are generic hubs, but may also be switching hubs. Transmission path lengths between the tonic node and individual dominant nodes are initially taken as equal for purposes of simplification. A rhythm node 20 is taken as embedded in the tonic node 0. The recitation makes reference to the time chart of FIG. 5. Due to diagrammatic constraints, FIG. 4 depicts an example of four dominant nodes. When a dominant node generates an outgoing message, it does not transmit that message immediately, but holds it internally. This applies likewise elsewhere herein. Further, the length of single messages transmitted from dominant nodes is taken to be equal, and these fixed-length messages are termed packets. The rhythm node 20 multicasts transmission instigation messages to regulate upstream transmissions. Since the messages are multicast, all dominant nodes receive them. Further, since the distances between the tonic node and the individual dominant nodes are equal, they reach all the dominant nodes simultaneously (S1 in FIG. 5) after an electrical delay corresponding to that distance. The dominant nodes have been allocated transmission sequence numbers beforehand and, in accordance with those transmission sequence numbers, transmit (S2, S3, S4 and S5 in FIG. 5) a predetermined number of outgoing messages in upstream transmission to the tonic node after the predetermined standby time (hereinafter, sometimes simply “standby time”) subsequent to reception of the transmission instigation message. In other words, they transmit outgoing messages that they had been holding. Transmission sequence numbers are discussed in detail below. Thus, upstream transmissions may be performed as dominant nodes maintain orderly intervals so that collisions do not occur, and without leaving gaps in time. When upstream transmissions through node 4 have completed, the rhythm node 20 allocates downstream transmission permission (S6 in FIG. 5) to the tonic node 0. The tonic node performs consecutive downstream transmissions (S7, S8, S9 and S10 in FIG. 5). The tonic node 0 then transmits a downstream transmission permission cession message (S11 in FIG. 5) to the rhythm node 20. After receiving the downstream transmission permission cession message, the rhythm node 20 again transmits transmission instigation messages (S12 in FIG. 5). FIG. 5 depicts gaps in time between packets in upstream transmissions from dominant nodes; this is to avert, when at the point upstream transmission from one dominant node has completed and the next dominant node performs upstream transmission, collision on the transmission path with the transmission of the previous dominant node. The time chart of FIG. 6 describes this in detail.

Thus, upstream transmissions do not collide because upstream transmissions are performed when triggered by transmission instigation messages from a rhythm node and the dominant nodes are synchronized time-wise. Nor do collisions occur between upstream transmissions and downstream transmissions, because downstream transmissions are not performed during an upstream transmission. The question of how the rhythm node 20 knows that downstream transmissions from the tonic node 0 have completed is as follows. A first method is for the rhythm node 20 to know that downstream transmissions have completed by monitoring all downstream transmissions. Drawbacks to this method, however, are that it places a large load on the rhythm node 20 and that when a network grows in complexity, it becomes problematic to situate the rhythm node 20 in a location where it can monitor all downstream transmissions. A second method is for the rhythm node 20 to determine the number of packets beforehand, when assigning downstream transmission permission. In this case, the rhythm node 20 may transmit the next transmission instigation messages after waiting the time required for those downstream transmissions. A third method is for a tonic node to transmit a downstream transmission permission cession message to the rhythm node when downstream transmissions from the tonic node have completed. FIG. 5 depicts an implementation of this third method. The predetermined standby times of individual dominant nodes may be calculated as follows.

Specification of Standby Times

Given Transmission Paths of Equal Length

Standby times are determined by the length of the transmission paths connecting the individual dominant nodes, transmission message length and the transmission speeds of the transmission paths. Transmission message length is expressed as L (bytes) and the transmission speed of the transmission path as S (bits per second). Standby time is expressed as T (nanoseconds). Transmission message lengths in transmissions from dominant nodes are taken to be an identical fixed length for a single transmission instigation message. The recitation first considers instances where transmission paths (621, 622 and 623) are of the same length. Each such length is expressed as D (meters). Let transmission path length (62)=transmission path length (63)=transmission path length (64). Let dominant nodes 1, 2 and 3 perform upstream transmission in that order. At the moment dominant node 1 completes transmission (T1), then, the terminal unit of the transmission data has passed through the segment of transmission path 621 connecting to the dominant node 1. D/(3×10ˆ8) seconds later, the last of the transmission data has then passed through the segment of transmission path 621 connecting to the hub. At that point (T2), it passes through the segment of transmission path 622 and transmission path 623 connecting to the hub and is traveling towards dominant node 2 and dominant node 3. 10ˆ8 is notation for ten raised to the power of eight. D/(3×10ˆ8) seconds after T2 (T3), the transmission data has passed through the segment connecting transmission path 622 and dominant node 2. The same applies to dominant node 3. In other words, it is known that from T1 to T3 requires 2D/(3×10ˆ8) seconds. Standby time Tn is expressed as Equation A below.

Formula 1
Tₙ=(n−1){8L/S)+2D/(3×10⁸)} Equation A

Strictly speaking, the distance from the transmission path (621, 622 or 623) to the transmission mechanism (91, 92 or 93) must be taken into account, but is calculated in the same fashion.

The time chart for the foregoing description is given in FIG. 6. After receiving a transmission instigation message (S1 in FIG. 6) from a rhythm node, a dominant node waits for a predetermined standby time based on its transmission sequence number and then makes a transmission to a tonic node (S2, S3, S4 and S5 in FIG. 6). Wait A in FIG. 6 is the wait for the upstream message length. Wait B is to avoid a collision between upstream transmissions where, as in FIG. 4, the communications apparatus directly connected to dominant nodes is a hub. This wait B is incurred when, for example, an upstream transmission message from dominant node 1 is also transmitted to dominant nodes 2 and 3. From the standpoint of a tonic node, the time required for this wait B is a period when there is no transmission from a dominant node. Where a configuration such as that of FIG. 4 is implemented, standby times increase in proportion to the length of transmission paths to which dominant nodes are connected. Therefore, the shorter the length of transmission paths to which dominant nodes are connected, the more preferable. Given the same conditions as specified above, i.e. a transmission path speed of 10 Gbps, a transmission message size of 256 bytes and no insertion bit, transmission time required per node is 204.8 ns. Where transmission paths (621, 622 and 623) are six meters in length, standby time B will then be 40 ns. Since the time required for transmission of a transmission message is 204.8 ns, this is not a small amount of time. Where the size of the transmission messages is greater than 256 bytes, standby time B will be proportionally smaller. Standby time B will also be proportionally smaller where transmission paths have a low transmission speed. Transmission message length, the transmission speed of transmission paths and the length of the transmission paths to which dominant nodes are connected must therefore be taken into account when employing this method.

Given Transmission Paths of Different Lengths 1

The foregoing recitation addresses instances of transmission paths of equal length. The recitation next addresses instances of transmission paths of different lengths. Let transmission path 621 have a length D1, transmission path 622 a length D2, transmission path 623 a length D3, transmission path 631 a length D4, transmission path 632 a length D5 and so on through D10. The general case is expressed as Dn. Also let dominant node 1 have a standby time T1, dominant node 2 a standby time T2 and so on through a standby time of T10 for dominant node 10. The general case is expressed as Tn. Let the order of upstream transmission be dominant node 1, dominant node 2, dominant node 3 . . . dominant node 10. The order of upstream transmission by the dominant nodes is determined by the transmission sequence number assigned to each dominant node. Here, dominant node 1 does not require a standby time for a transmission instigation message. Because transmission paths 62, 63 and 64 are of equal length, the transmission instigation message from the rhythm node 20 reaches the hubs at the same time. Dominant nodes 2, 3 . . . 10 each require a standby time. This standby time is expressed as Equation B below.

Formula 2
Tₙ=Tₙ₋₁+(Dₙ₋₁+Dₙ)/(3×10⁸)+(n−1)(8L/S) Equation B
Given Transmission Paths of Different Lengths 2

The recitation next addresses transmission paths 62, 63 and 64 of different lengths. Let transmission path 62 have a length E1, transmission path 63 a length E2 and transmission path 64 a length E3. The equations expressing standby times T1, T2, T3 . . . T10 of dominant nodes 1, 2, 3 . . . 10 are, Equation B for dominant nodes connected to hub 51. Equation C below for dominant nodes connected to hub 52.

Formula 3
Tₙ=Tₙ₋₁+((E₁−E₂)+(Dₙ₋₁+Dₙ))/(3×10⁸)+(n−1)(8L/S) Equation C
Equation D below for dominant nodes connected to hub 53.
Formula 4
Tₙ=Tₙ₋₁+((E₁−E₃)+(Dₙ₋₁+Dₙ))/(3×10⁸)+(n−1)(8L/S) Equation D

Thus, the standby time of a dominant node is the standby time for the hub directly connected to the dominant node plus the standby time for the dominant node. The foregoing recitation describes the definition of standby times with the lengths of transmission paths, but the actual time may also be measured by exchanging signals between the hub and the dominant node or between the rhythm node and the dominant node, as with a Packet Internet Groper (PING). The distance between a hub and a router may also be measured in like fashion. Hubs and routers should be equipped with such functionality. This method is applicable likewise below. The recitation following concerns the utilization of final communications apparatus and intermediate communications apparatus, which may be transposed with hubs and routers with respect to distance and time. Maximum transmission-path length may also be specified as the distance to all dominant nodes. Although this will result in dominant nodes with short transmission paths having predetermined standby times defined longer than necessary, it simplifies the calculation and definition of predetermined standby times. This approach is applied in examples employed below.

The foregoing recitation is concerned with upstream transmission. Downstream transmissions are transmissions from a tonic node to dominant nodes. Like dominant nodes, a tonic node does not send transmission messages immediately upon their generation, but holds them internally. This applies likewise elsewhere. Once a cycle of upstream transmission has completed, downstream transmissions may be performed by consecutively sending the accumulated messages from the tonic node to the dominant nodes. This method applies also to instances where upstream and downstream transmission paths are not segregated.

Cascade Connection: Upstream and Downstream Segregation

In the foregoing recitation, vacant time is inserted between tonic node reception and each transmission message as in the time chart of FIG. 6, rather than the idealized time chart of FIG. 5. FIG. 7 provides an example of how to eliminate such vacant time. In this drawing, the dominant nodes have direct connections not with hubs, but with final communications apparatuses, and their transmission paths (e.g. 621 and 721) are divided into upstream and downstream transmission paths. Transmission paths between an intermediate communications apparatus and the final communications apparatuses, and between a node 0 and the intermediate communications apparatus, are likewise divided into upstream and downstream transmission paths.

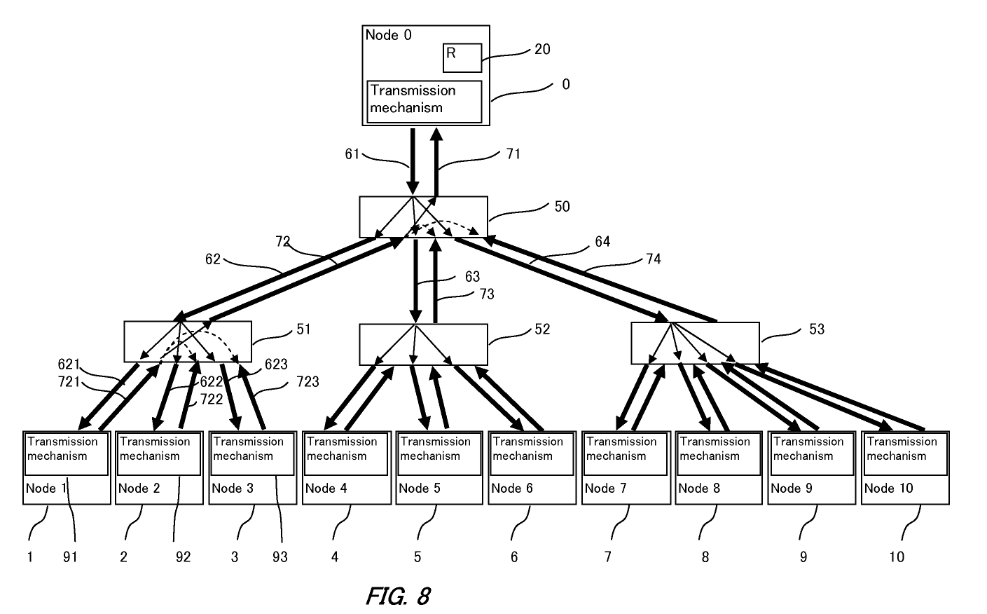

Here, the final communications apparatuses (50, 51, 52 and 53) perform downstream transmissions to all nodes. On the other hand, transmissions from a given node are transmitted in an upstream direction, but are not transmitted to other nodes connected to the same communications apparatus. This communications apparatus scheme is depicted in FIG. 8. In FIG. 8 downstream transmissions are sent to all dominant nodes. A final communications apparatus 50 transmits data from a transmission path 61 along transmission paths 62, 63 and 64. A final communications apparatus 51 transmits data from the transmission path 62 along transmission paths 621, 622 and 623.

FIG. 8 depicts a state of upstream transmission from a dominant node 1 in which it is not transmitted from dominant node 1 to a dominant node 2 or a dominant node 3 by the final communications apparatus 51. This state is indicated in FIG. 8 by dotted lines. Likewise, the final communications apparatus 50 transmits upstream transmissions from transmission path 72 along transmission path 71, but does not transmit them along transmission paths 73 and 74. No transmissions are made from dominant node 4 to dominant node 10.

Standby Time

Given Transmission Paths of Equal Length

Where the foregoing configuration is implemented, the standby times of individual dominant nodes will be as follows. This assumes a rhythm node 20 provided to a tonic node 0.

Standby time is determined by the lengths of the transmission paths to which a dominant node is connected, transmission message length and the transmission speeds of transmission paths. Let the transmission message length be L (bytes) and the transmission speed of a transmission path be S (bits per second). Let standby time with respect thereto be T (ns). Let the lengths of transmission paths (62, 63, 64, 72, 73 and 74) be thus: transmission path length (62)=transmission path length (72); transmission path length (63)=transmission path length (73); and transmission path length (64)=transmission path length (74). Also, let transmission path length (62)=transmission path length (63)=transmission path length (64). The recitation thus first addresses instances where transmission paths (621, 622 and 623) are of the same length. Their individual lengths are expressed as D (meters). Also, let transmission path length (62)=transmission path length (63)=transmission path length (64). Let the order of upstream transmission be dominant node 1, dominant node 2, dominant node 3. At the moment that dominant node 1 has completed transmission (T1), then, the last of the transmission data has passed through the segment of transmission path 621 connecting to the dominant node 1. If a transmission message from dominant node 2 is transmitted at time T1, it will not collide with the transmission message from dominant node 1. Standby time Tn is expressed as Equation E below.

Formula 5
Tₙ=(n−1)(8L/S) Equation E

Strictly speaking, the distance from the transmission path (621, 622 or 623) to the transmission mechanism (91, 92 or 93) must be taken into account, but here is taken to be equal. The time chart for the foregoing description is given in FIG. 5. This disposes of the wait B discussed above and allows transmission messages from a dominant node received by a tonic node to arrive without leaving gaps in time.

Given Transmission Paths of Different Lengths 1

The foregoing recitation addresses instances of transmission paths of equal length. The recitation next addresses instances of transmission paths of different lengths. Let transmission path 621 have a length D1, transmission path 622 a length D2, transmission path 623 a length D3, transmission path 631 a length D4, transmission path 632 a length D5 and so on through D10. The general case is expressed as Dn. Also let dominant node 1 have a standby time T1, dominant node 2 a standby time T2 and so on through a standby time of T10 for dominant node 10. The general case is expressed as Tn. Let the order of upstream transmission be dominant node 1, dominant node 2, dominant node 3 . . . dominant node 10. Here, dominant node 1 does not require a standby time for a transmission instigation message. Because transmission paths 62, 63 and 64 are of equal length, the transmission instigation message from the rhythm node 20 reaches the hubs at the same time. Dominant nodes 2, 3 . . . 10 each require a standby time. This standby time is expressed as Equation F below.

Formula 6
Tₙ=Tₙ₋₁+(Dₙ₋₁−Dₙ)/(3×10⁸)+(n−1)(8L/S) Equation F
Given Transmission Paths of Different Lengths 2

The recitation next addresses transmission paths 62, 63 and 64 of different lengths. Let transmission path 62 have a length E1, transmission path 63 a length E2 and transmission path 64 a length E3. The equation expressing standby times T1, T2, T3 . . . T10 of dominant nodes 1, 2, 3 . . . 10 is Equation F for dominant nodes connected to a final communications apparatus 51. Equation G below is applied to dominant nodes connected to a final communications apparatus 52.

Formula 7
Tₙ=Tₙ₋₁+((E₁−E₂)+(Dₙ₋₁−Dₙ))/(3×10⁸)+(n−1)(8L/S) Equation G
Equation H below is applied to dominant nodes connected to a final communications apparatus 53.
Formula 8
Tₙ=Tₙ₋₁+((E₁−E₃)+(Dₙ₋₁−Dₙ))/(3×10⁸)+(n−1)(8L/S) Equation H
Clock Deviation

The foregoing recitation concerning Equations A, B, C, D, E, F, G and H does not include clock deviation in its calculations, but collisions may be averted even where clock deviation obtains by the insertion of a wait C as follows such that that much standby time is implemented. Let the probability of clock deviation be R. Time Tn regulating clock deviation for an individual node is Equation I below.

Formula 9
Tₙ=2×8FR/S Equation I

This Equation I adds to standby time to account for the clock deviation of individual dominant nodes; where a configuration such as that of FIG. 4 is implemented and the upstream data of a node connected to a final communications apparatus is transmitted to another node connected to the same final communications apparatus, the following applies. When a dominant node 1 is transmitting outgoing data, for example, a dominant node 2 and a dominant node 3 are receiving the outgoing data of dominant node 1. When dominant node 2 transmits outgoing data following dominant node 1, therefore, there is no need to take into consideration the delay between them. This applies likewise when dominant node 3 transmits outgoing data following dominant node 2. In other words, where a configuration such as that of FIG. 4 is implemented, standby time need not be inserted to account for clock deviation between dominant nodes connected to the same final communications apparatus. This means that the standby time of Equation I must be inserted when switching from a dominant node connected to one final communications apparatus to a dominant node connected to a different final communications apparatus.

The foregoing recitation addresses upstream transmissions. Since downstream transmissions are on transmission paths segregated from upstream transmissions, where there is a single tonic node, downstream transmissions may be performed from the tonic node to each dominant node consecutively. However, because transmission of the subsequent transmission instigation message is a downstream transmission, there is a possibility of collision with a download transmission from the tonic node. Or, transmission of a transmission instigation message must wait until downstream transmissions are completed. To avert such a development, upstream transmission and downstream transmission may be performed more smoothly by transmitting from the tonic node messages in a quantity determined by the rhythm node, then suspending downstream transmission and transmitting transmission instigation messages from the rhythm node, and then again performing downstream transmission from the tonic node. Such restriction by the rhythm node of the number of messages transmitted by the tonic node is part of the allocation of transmission permission. Methods of allocating transmission permission include the rhythm node monitoring for the completion of downstream transmission by the tonic node, the tonic node transmitting to the rhythm node a message reporting that downstream transmission by the tonic node has completed, and where the rhythm node specifies the number of downstream transmissions, monitoring the time required for those downstream transmissions.

Nonuniform Upstream Transmission

Where the communications system of FIGS. 4 through 7 is implemented, the following problem arises. Although upstream transmissions are performed seamlessly when upstream transmission messages are present uniformly in all dominant nodes, upstream transmissions may in fact be present nonuniformly. While there would be no upstream transmission from a dominant node lacking upstream transmission messages, upstream transmissions may accumulate in other dominant nodes.

Utilization of Empty Packets

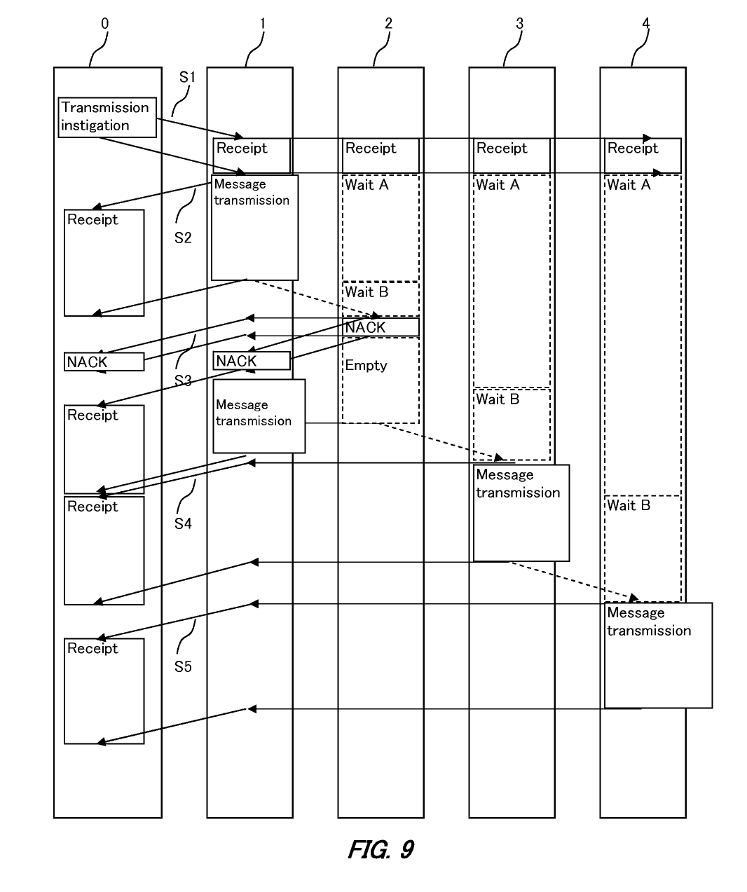

The following method may be employed to remedy such a circumstance. A first method is for other dominant nodes to utilize empty packets. Although these may not be utilized in the configuration of FIG. 7, they may be utilized in the configuration of FIG. 4. As depicted in FIG. 9, when a dominant node 2 lacks transmission messages, the dominant node 2 transmits a NACK. In this case the message length is not the fixed length determined in each transmission instigation but a predetermined NACK length, and the remainder is no signal. The NACK is transmitted to another dominant node connected to the same final communications apparatus as dominant node 2. A dominant node 1 detects it and utilizes the no-signal portion to transmit upstream data from the dominant node 1.

Multiple Communications Units

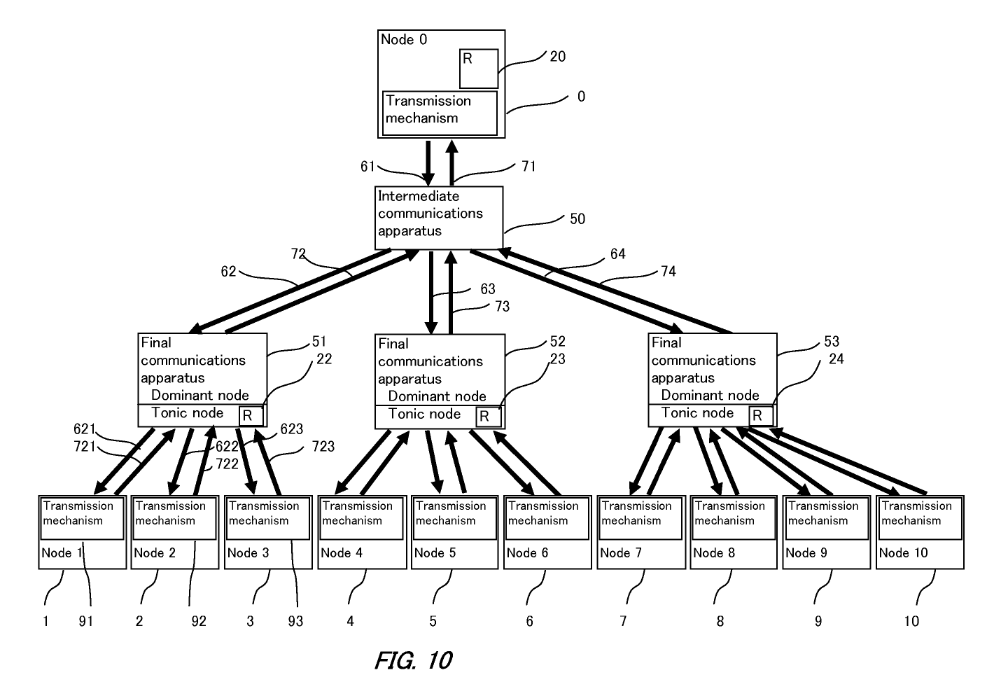

However, the foregoing method may not be employed with the configuration of FIG. 7, and upstream transmissions of different message lengths would be commingled. Multiple communications units (a multilevel rhythm node) are a way of resolving this issue. The recitation makes reference to FIG. 10. Here, the upper halves of final communications apparatuses 51, 52 and 53 are dominant nodes, and their lower halves are tonic nodes. As seen from a node 0, i.e. a tonic node, the final communications apparatuses of FIG. 10 are dominant nodes. On the other hand, the final communications apparatus 51, for example, is the tonic node of other nodes 1, 2 and 3 connected to that final communications apparatus. Nodes 1, 2 and 3 are dominant nodes of the final communications apparatus 51. Nodes 1, 2 and 3 are further nodes having no relationship with node 0. This applies entirely likewise to the relationship between the final communications apparatus 53 and nodes 4, 5 and 6, and to the relationship between the final communications apparatus 53 and nodes 7, 8 , 9 and 10.

Communications Units

The recitation here addresses the example of the final communications apparatus 51 and nodes (1, 2 and 3) connected to it, but it applies entirely likewise to the other final communications apparatuses (52 and 53). The final communications apparatus 51 and the nodes (1, 2 and 3) connected to it are termed a single communications unit. A communications unit requires a dominant node, a tonic node, a transmission path and a rhythm node. As rhythm node 22 is a functionality, as stated above, it is reckoned in this recitation to be included in the final communications apparatus 51. The final communications apparatus 51 multicasts transmission instigation messages as a rhythm node. The transmission instigation messages use transmission paths 621, 622 and 623. Transmission instigation messages from the final communications apparatus 51 will therefore not reach other communications units. After receiving a transmission instigation message as dominant nodes, nodes 1, 2 and 3 send transmission messages to the final communications apparatus 51 after waiting their predetermined standby times. The final communications apparatus 51 accumulates upstream transmission messages from the dominant nodes. The predetermined standby times are obtained by combining Equation I with Equation E or Equation F. When one cycle of upstream transmissions from the dominant nodes has completed, the final communications apparatus 51 transmits downstream transmission messages to nodes 1, 2 and 3. The final communications apparatus 52 and the final communications apparatus 53 perform transmissions with dominant nodes in like fashion.

Thus, upstream transmission messages collected in the final communications apparatuses are transmitted to the tonic node 0 in the transmissions of a communications unit comprising node 0, an intermediate communications apparatus 50 and the final communications apparatuses 51, 52 and 53. This communications unit is termed communications unit α. The communications unit made up of the final communications apparatus 51 and nodes 1, 2 and 3 is termed communications unit β, a communications unit made up of the final communications apparatus 52 and nodes 4, 5 and 6 is termed communications unit γ, and a communications unit made up of the final communications apparatus 53 and nodes 1, 2 and 3 is termed communications unit δ. A rhythm node 20 is embedded in the tonic node 0 in the communications unit α. The rhythm node 20 first multicasts a transmission instigation message. Because communications would be in disarray when the transmission instigation message arrives at the nodes 1, 2, 3 . . . 10 if it is fully multicast, it is group-multicast. Group multicasting consists of grouping together specific nodes on a communications network. When such group multicasting is employed, the transmission instigation message from the rhythm node 20 is transmitted to the final communications apparatuses 51, 52 and 53. After receiving the transmission instigation message, each final communications apparatus performs upstream transmissions after waiting the predetermined standby time. These upstream transmission messages are the accumulated messages transmitted from dominant nodes 1, 2 and 3. When one cycle of upstream transmission has completed, the tonic node performs downstream transmission. The switch to downstream transmission is performed by the rhythm node. Standby time here is obtained by reading Equation E or Equation F for the predetermined standby time and adding Equation I thereto. This consists of interpreting the distance between the final communications apparatus and the dominant node expressed in Equations E and F as the distance between a tonic node and a final communications apparatus. The several rhythm nodes of communications unit α, communications unit β, communications unit γ and communications unit δ need not be synchronized with each other and may operate independently.

Multilevel Configuration

The foregoing recitation describes a configuration in which a communications unit is divided over the upper and lower halves of a final communications apparatus, and a configuration is also possible in which a communications unit is divided over the upper and lower halves of an intermediate communications apparatus. The foregoing recitation describes a multilevel rhythm node having an upper and a lower level, and it would function entirely likewise with further layers added. Where a multilevel rhythm node is thus used, overall transmission speed may be improved even if the speed of transmission paths between the dominant nodes and the final communications apparatus is lower than the speeds of other transmission paths. Where there is a large number of dominant nodes within a single communications unit, standby times will grow by the amount of the relatively high clock deviation consequent, but since the number of dominant nodes per communication unit may be fewer with a multilevel rhythm node than when the whole is a single communications unit, standby time resulting from clock deviation may be reduced. Additionally, while Ethernet® is limited with respect to the number of layers, multilayer rhythm nodes have no such requirements with respect to limitations on the number of layers. A fractal communications system may thus readily be configured by providing multiple communications units and configuring them in multiple layers.

Transmission of Multiple Messages

With communications unit α, upstream transmission may be of one message at a time from the dominant nodes, but where there are few final communications apparatuses, the number of transmission instigation message transmissions will increase and, as seen in a time chart, non-message-transmission time will increase relative to message-transmission time. One way to avert this is, with communications unit α, for upstream transmission from dominant nodes to be of, for example, ten messages per transmission instigation message. This consists of defining the volume of transmissions from individual dominant nodes to ten messages when determining beforehand the volume of upstream transmission. The predetermined standby time of individual dominant nodes in this case will, of course, be a value scaled to ten messages.

Acquisition of Transmission Permission by Dominant Nodes

Where dominant nodes operate with their power turned on in the morning and turned off in the evening, the question arises of how to specify the sequence numbers of dominant nodes. Allocation of these transmission sequence numbers constitutes the assignment of upstream transmission permission. One method is to allocate a fixed sequence number to all dominant nodes. Another method is to allocate sequence numbers when the dominant nodes boot. Or, dominant nodes may send a broadcast message when powered on and booted, notifying other nodes that they have connected to the communications network. Where the method of allocating sequence numbers when dominant nodes are booted is implemented, those messages must be transmitted to the rhythm node. Since it cannot be anticipated when these messages will be issued, there is a possibility that transmissions such as those described herein may lead to collisions. If, when the rhythm node sends a transmission instigation message, the next transmission instigation message is sent after a definite period of time following upstream transmissions from the dominant nodes, there is a possibility that the message that a dominant node has booted will be transmitted in that period of no transmissions, decreasing the likelihood of collision. However, the utilization rate of transmission paths will decrease. If dominant nodes are assigned fixed numbers, on the other hand, the broadcast message at the time some given dominant node is powered on may be included in transmission instigation because dominant nodes performing upstream transmission are fixed by transmission instigation from the rhythm node, eliminating the possibility of collision. However, where a method of assigning fixed sequence numbers is implemented, a large number of unbooted dominant nodes will lead to transmission inefficiency.

One solution is a method of leaving empty the first packet following transmission instigation. This first packet may be transmitted by a dominant node lacking a sequence number at that time. Although this does entail the possibility of a collision encountering this first packet, since the node will not be notified of its transmission sequence number in the event of a collision, the transmission sequence number may be established by again transmitting from the dominant node after a suitable interval.

Transmission Instigation Addressed to a Specific Dominant Node

Even where such measures as the foregoing are taken, the volume of upstream transmission may vary widely among final communication apparatuses at any given time. A method follows that may be implemented to cope with such bias in transmission volume. Although a transmission instigation message will normally be multicast to all dominant nodes in a communications unit, a transmission instigation message may also be addressed to a specific dominant node. When a transmission instigation message is addressed to a specific dominant node, the dominant node that receives it (dominant node X) performs upstream transmission without waiting the predetermined standby time. In this case, if the next transmission instigation message is again a transmission instigation message to a different dominant node (dominant node Y), dominant node Y performs upstream transmission without waiting the predetermined standby time, and so there is a possibility of collision between the upstream transmission of dominant node X and the upstream transmission of dominant node Y, depending on the respective distances between dominant node X and the tonic node and between dominant node Y and the tonic node. When sending the transmission instigation message to dominant node Y, the rhythm node either calculates the transmission delay resulting from each distance and sends the transmission instigation message, or sends the transmission instigation message to dominant node Y after the upstream transmission from dominant node X has completed. Alternatively, the rhythm node may be notified of which dominant nodes have large numbers of upstream messages by a method of transmitting upstream messages from a dominant node with the volume of upstream transmission embedded in the accumulated transmission messages, or using some given transmission message to transmit the upstream transmission volume. Or, the transmission instigation message may be given an attribute, and the attribute indicating upstream transmission distinguished from that indicating transmission of the count of upstream transmission messages. A transmission instigation message indicating transmission of the count of upstream transmission messages is transmitted, and the count of upstream transmission messages from individual dominant nodes made. Where a method is implemented of embedding the volume of accumulated upstream transmission in an outgoing message, the rhythm node reads outgoing messages addressed to tonic nodes. Where a method is implemented of using some given outgoing message to transmit the volume of upstream transmission, on the other hand, that outgoing message may be addressed to the rhythm node.

Assignment of Multiple Transmission Sequence Numbers

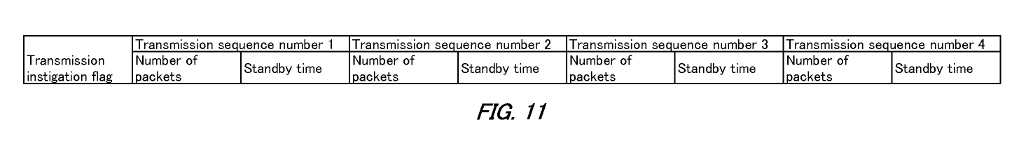

In a method other than the foregoing, where a specific dominant node generally has a large volume of transmissions, that dominant node may be assigned multiple transmission sequence numbers. Since a node 1 has a greater transmissions volume than a node 2 or 3, for example, node 1 is assigned transmission sequence numbers 1, 2 and 3, node 2 is assigned transmission sequence number 4, and node 3 is assigned transmission sequence number 5. Node 1 would thus perform three rounds of upstream transmission, and nodes 2 and 3 one round of upstream transmission each, in response to a transmission instigation message. Predetermined standby times in this case would be standby times defined by the transmission sequence numbers. In other words, in the Tn of node 2, n=4.

Where a method is employed, as of the foregoing, of transmitting the counts of upstream messages from dominant nodes, such methods as follow become available for minimizing queued messages in individual dominant nodes. This entails sending a transmission instigation message such as that of FIG. 11 from the rhythm node. For purposes of simplification, FIG. 11 depicts an instance of dominant nodes 1 through 4. It also omits addressing and other data. The number of allocated packets per transmission sequence number is determined and specified therein. Because each dominant node will have a different predetermined standby time where the number of allocated packets is one for each of them and where the number of allocated packets is other than one for some of them, the standby time should be specified in the transmission instigation message. Standby time Tn in this case is expressed as Equation J, where Pn is the number of packets allocated to the dominant node of each transmission sequence number.

Formula 10
Tₙ=Tₙ₋₁+(Dₙ₋₁−Dₙ)/(3×10⁸)+(n−1)(8LPₙ₋₁/S) Equation J

However, this does not apply to Tn where Pn=0. Where the number of transmission packets is zero, Tn is not calculated. When calculating Tn+1, Equation J is applicable by reading n+1 for n. The calculation may likewise be performed by applying Pn in Equations G and H. Transmission efficiency is thus maximized by thus allocating the number of packets and the standby time to the individual dominant nodes, although the transmission instigation message increases in length.

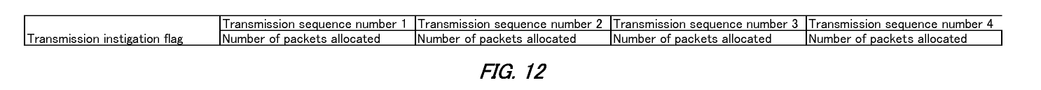

Further, a transmission instigation message with only the number of packets allocated to each dominant node may be transmitted, as in FIG. 12. This entails calculation by each dominant node of the standby time of the individual dominant nodes. In this case, the formula and conditions on which the calculation is premised must be transmitted to the dominant nodes beforehand by a tonic node.

The foregoing methods are also applicable where upstream and downstream transmission paths from dominant nodes are not segregated, as in FIG. 4, if upstream transmission from some given dominant node is not transmitted to another dominant node by the final communications apparatus

Cascade Connections: Partial Upstream/Downstream Segregation

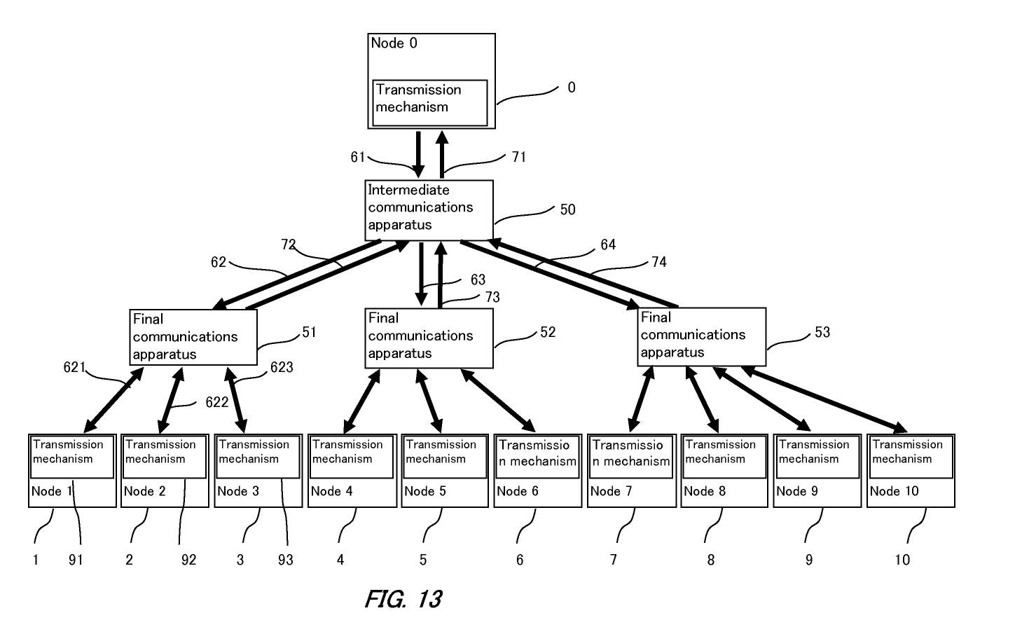

The foregoing recitation thus addresses instances of upstream and downstream non-segregation of transmission paths and instances of upstream and downstream segregation of transmission paths in a communications network having cascade connections. FIG. 13 depicts a compromise configuration. In the drawing, transmission paths between final communications apparatuses and an intermediate communications apparatus and between the intermediate communications apparatus and a tonic node are segregated into upstream and downstream transmission paths. On the other hand, transmission paths between final communications apparatuses and dominant nodes are not segregated into upstream and downstream transmission paths, but consist of single transmission paths. Here, the whole of FIG. 13 may comprise a single communications unit, or may be divided into the four communications units α, β, γ and δ, as recited above.

The recitation first addresses a configuration in which the whole of FIG. 13 comprises a single communications unit. Here, nodes 1, 2, 3 . . . 10 are dominant nodes, and node 0 is a tonic node. Transmissions have fundamentally the same framework as that of the configuration depicted in FIG. 7. Transmission instigation messages are multicast by a rhythm node, and the dominant nodes successively transmit upstream transmission messages to the tonic node after their predetermined standby times. Since upstream transmissions are performed thus, collisions do not occur. Where upstream transmissions from some given dominant node are transmitted to another node connected to the final communications apparatus to which the former dominant node is connected, Equation A or Equation B is applied to obtain standby time. Or, where upstream transmission from some given dominant node are not transmitted to other nodes connected to the final communications apparatus to which the former dominant node is connected, Equation E or Equation F is applied to obtain standby time.

Because downstream transmission from the tonic node is here performed concurrently with upstream transmission, an upstream transmission and a downstream transmission may collide on transmission paths 621 and 622. There is lower probability of collision if the upstream transmission and the downstream transmission are performed with different counterparties, as to avert this possibility may be achieved by, where downstream transmission from the tonic node is performed immediately subsequent to transmission of a transmission instigation message, commencing the downstream transmission with dominant node 5 rather than commencing it with dominant node 1. More strictly, the possibility of collision may be eliminated by performing downstream transmission to a dominant node after the completion of upstream transmission from the dominant node to which that downstream transmission is addressed.

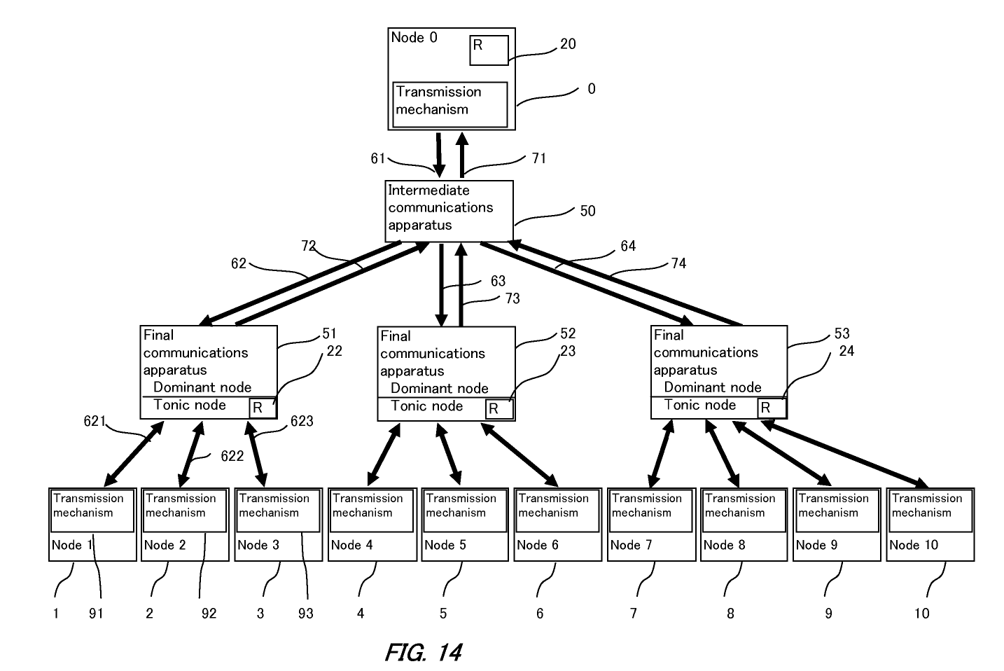

Further, a configuration may be comprised of multiple communications units by providing final communications apparatuses with tonic node and dominant node functionality, as in FIG. 14. Because upstream and downstream transmission messages accumulate at the final communications apparatus in this configuration, there is no possibility of collision on the transmission path 621 or other transmission paths.

Transmissions Between Dominant Nodes

The foregoing recitation describes a method of performing transmissions between a tonic node and dominant nodes without difficulty and without collisions. However, it would not be possible to perform transmissions between dominant nodes in such an implementation of a communications network. In FIG. 13, where transmissions between dominant nodes to a final communications apparatus are transmitted to another dominant node connected to the same final communications apparatus, a transmission from dominant node 1 to dominant nodes 2 and 3, for example, would be performed via a final communications apparatus 51. However, it would not be possible to perform transmissions between dominant node 1 and dominant nodes 4, 5, 6 . . . 10. However, in FIG. 13 and also in FIGS. 7, 8 and 10, where transmissions between dominant nodes to a final communications apparatus are not transmitted to other dominant nodes connected to the same final communications apparatus, it would not be possible to perform transmissions between dominant node 1 and dominant nodes 2 and 3, for example. To perform such transmissions, a tonic node for transmissions between dominant nodes is provided as a tonic node. To perform a transmission between dominant node 1 and dominant node 4, for example, an upstream transmission from dominant node 1 is first transmitted within communications unit β to the final communications apparatus 51 (functioning here as a tonic node).

Next, a downstream transmission from the tonic node for transmissions between dominant nodes is transmitted within communications unit α to a final communications apparatus 52 (functioning here as a dominant node). Next a download transmission from the final communications apparatus 52 (functioning here as a tonic node) is transferred within communications unit γ to dominant node 4. Transmissions addressed to dominant node 1 from dominant node 4 are performed in reverse.

Transmission Addressees

Now, where there are multiple partitioned communications units, as in the foregoing recitation, the problem arises of how to specify destination in, for example, a transmission from dominant node 1 to dominant node 4. In order to resolve this problem, two addressees are used: a primary addressee and a secondary addressee. The recitation makes reference to FIG. 10. A transmission from dominant node 1 to dominant node 4 would arrive at dominant node 4, as described in the foregoing recitation, via the final communications apparatus 51, an intermediate communications apparatus 50, the tonic node for inter-node transmission between dominant nodes (node 0 in FIG. 10 postulated as the tonic node for inter-node transmission), the intermediate communications apparatus 50 and the final communications apparatus 52. The ultimate addressee from dominant node 1 here is dominant node 4, but transmission of the upstream transmission message from dominant node 1 cannot be performed with dominant node 4 as the addressee. The transmission from dominant node 1 to the tonic node 0 for inter-node transmission is separated from the transmission from the tonic node 0 for inter-node transmission to dominant node 4. The tonic node 0 for inter-node transmission is the addressee when transmitting an upstream transmission message from dominant node 1. This is the primary addressee. A message having only a primary addressee will not reach dominant node 4. Therefore, the upstream transmission message has a secondary addressee, the content of which is dominant node 4. In the transmission from dominant node 1 to the tonic node 0 for inter-node transmission the message is of a format having a primary addressee and a secondary addressee, and the message reaches the tonic node 0 for inter-node transmission due to the primary addressee. The tonic node 0 for inter-node transmission looks at the secondary addressee in this message, creates a new transmission message addressed to that secondary addressee, and the message is transmitted as a downstream transmission message from the tonic node 0 for inter-node transmission. The tonic node 0 for inter-node transmission may thus be employed to perform transmissions between dominant nodes by including a primary addressee and a secondary addressee in a message.

Transmission Addressee Routing

The foregoing recitation addresses a method of using a primary addressee and a secondary addressee, and transmissions may also be performed by means of routing control without using a primary addressee and secondary addressee by providing an intermediate communications apparatus with functionality for sorting by addressee and the tonic node for inter-node transmission loading inter-node transmission messages other than those addressed to itself. In a transmission from dominant node 1 to dominant node 4, for example, the addressee of the transmission message would be dominant node 4. The intermediate communications apparatus 50 recognizes that the transmission is not addressed to a tonic node, but is an inter-node transmission, and sends the message to the tonic node for inter-node transmission. The tonic node for inter-node transmission receives and holds the message. Next, when allocated downstream transmission permission by the rhythm node, it sends the message as a downstream transmission. Dominant node 4 receives the message.

Non-Multicasting Transmission Instigation

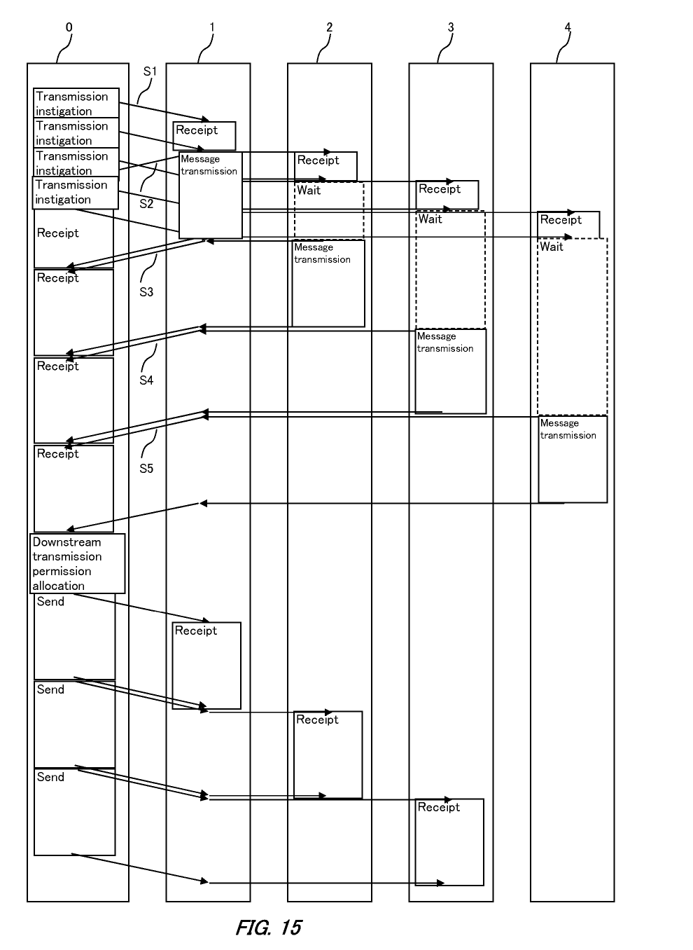

The foregoing recitation describes transmission instigation messages as multicast by the rhythm node. Additionally, group multicasting is employed for multicasting on a communications network comprising multiple communications units. However, group multicasting results in the multicast reaching all nodes capable of transmission that are connected to the communications network. Even where a router or other functionality for sorting transmissions by addressee is available, it is not thus possible to perform sorting. A solution is to employ a method of transmitting the transmission instigation messages to individual dominant nodes. Given the configuration of FIG. 4, the time chart describing the transmission of a multicast transmission instigation message is that of FIG. 5, and the time chart of FIG. 15 describes the successive transmission of a transmission instigation message to individual dominant nodes. Here, node 0 is the rhythm node and is sending a transmission instigation message successively to dominant nodes 1, 2, 3 and 4. After receiving the transmission instigation message, each of the dominant nodes sends upstream transmission messages after waiting its predetermined standby time. The predetermined standby time is shorter here than in FIG. 5 by the amount of time taken to send the transmission instigation message from the rhythm node. However, a shortcoming of this method is that there is less time to perform downstream transmissions from tonic nodes.

Use of Hubs

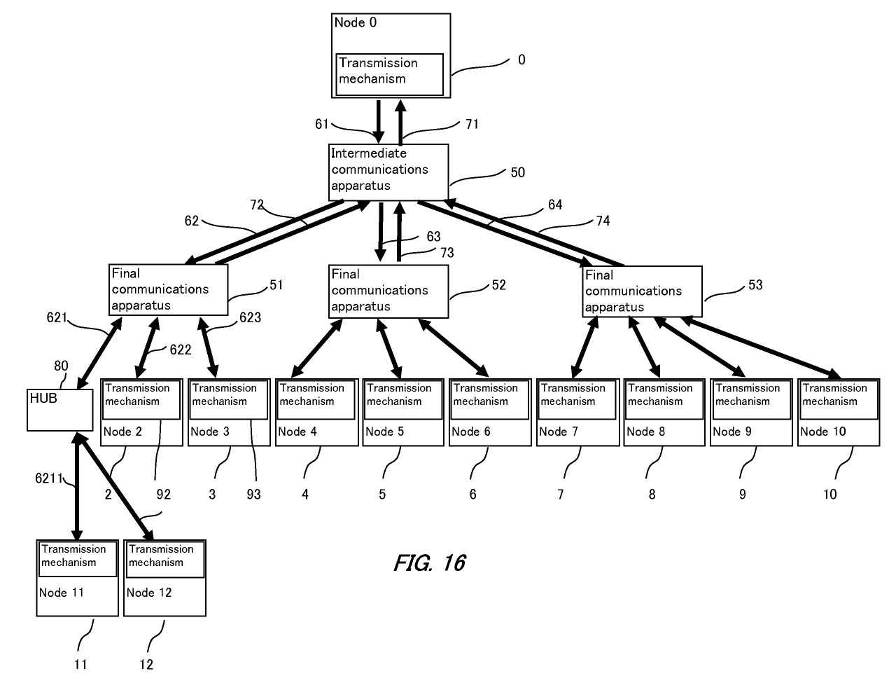

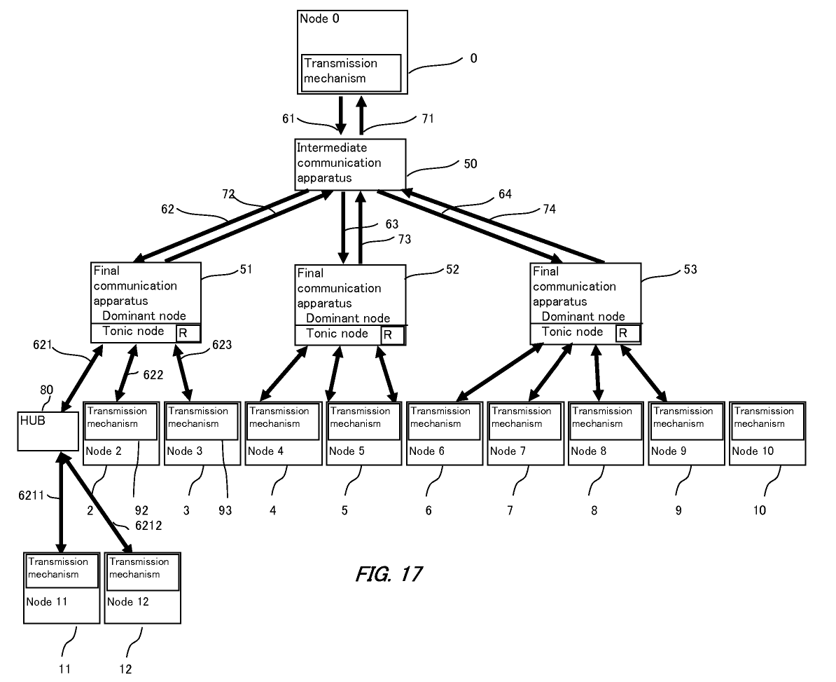

In the configurations of FIG. 10 and FIG. 13, dominant nodes are connected directly to final communications apparatuses. However, where final communications apparatuses do not have many ports, a multitude of dominant nodes may be connected to a single final communications apparatus by using hubs and without using a multitude of final communications apparatuses. FIGS. 16 and 17 illustrate such a configuration. FIG. 16 is an example of a final communications apparatus 51 that does not have the functionality of a tonic node. On the other hand, FIG. 17 is an example of a final communications apparatus 51 that has the functionality of a tonic node. In both drawings, a hub 80 is connected to the final communications apparatus 51, and dominant nodes 11 and 12 are connected to the hub 80. In this case, the length of the transmission paths of the dominant nodes 11 and 12 are transmission path 621 plus transmission path 6211 for the dominant node 11, and transmission path 621 plus transmission path 6212 for the dominant node 12. Standby times corresponding to these distances may be defined to the respective dominant nodes.

Although the drawings include only one hub for purposes of simplification, other configurations are also possible in which multiple hubs are provided to a single final communications apparatus or additional, subordinate hubs are connected to a hub connected to a final communications apparatus. Particularly where a final communications apparatus has the functionality of a tonic node and of a dominant node, as in FIG. 17, there is a chance that the final communications apparatus is costly, and this is an effective means of reducing the number of final communications apparatuses. Hubs utilized in this fashion should not employ buffering. The reason is that since buffering results in transmission delays, collisions may result from transmission delays, for example when node 3 makes a transmission next after node 11.

Multiple Tonic Nodes

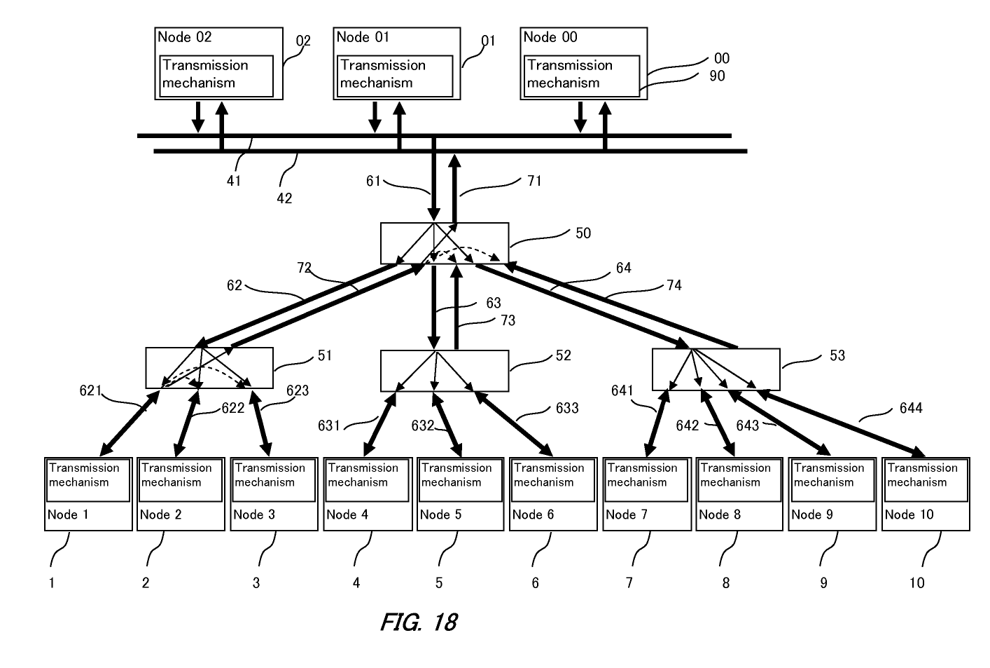

The foregoing recitation has discussed instances of a single tonic node. In real-world environments, instances of multiple tonic nodes are more common. The recitation below addresses instances of multiple tonic nodes. FIG. 18 is an example of an instance where three tonic nodes are present. Node 00, node 01 and node 02 are tonic nodes. These are connected to a transmission path 41 and a transmission path 42. The distance between the tonic node 00, the tonic node 01 and the tonic node 02 should be short. Such a communications network is assumed to comprise a single communications unit. This communications unit is provided with a rhythm node. As discussed in the foregoing recitation, a rhythm node is a functionality and may be provided as standalone hardware or may be provided internally within any one of tonic node 00, 01 or 02 or internal to an intermediate communications apparatus 50. The recitation below assumes it provided internally within the intermediate communications apparatus 50.

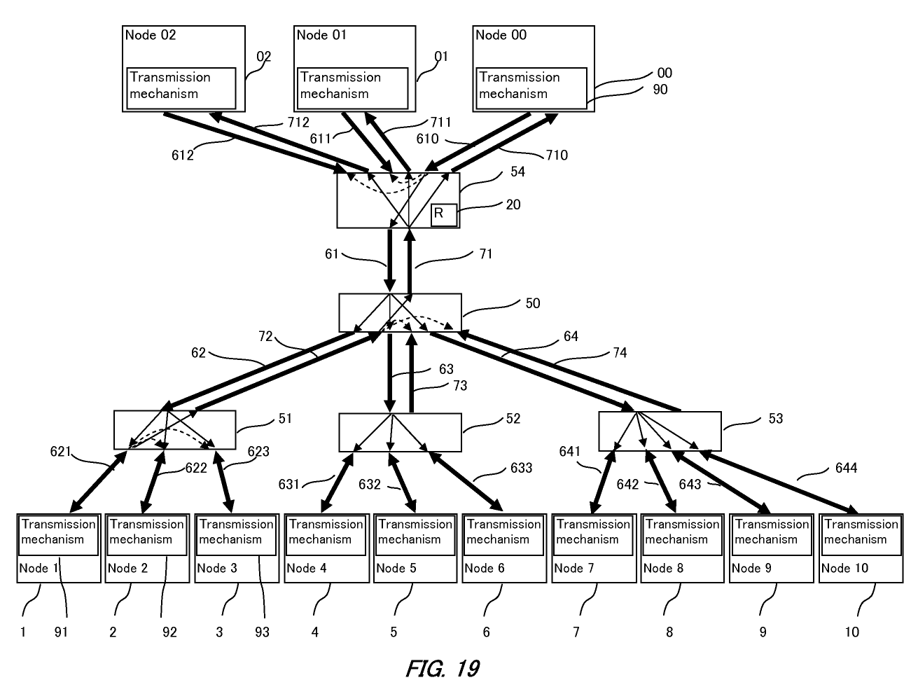

FIG. 19 is an example in which multiple tonic nodes are connected in a star topology, as seen from an intermediate communications apparatus 54. This intermediate communications apparatus 54 is installed facing in the opposite direction from an intermediate communications apparatus 50. The same advantages may be obtained from both FIG. 18 and FIG. 19, but the recitation will address the example of FIG. 19 because that is reckoned to be the more common as an actual implementation. In FIG. 19, a rhythm node 20 is provided internally within the intermediate communications apparatus 54. The same advantages may be obtained from providing a rhythm node internally within the intermediate communications apparatus 50.

The recitation first addresses upstream transmission. The rhythm node 20 sends transmission instigation messages. Transmission instigation messages should be multicast, but they may also be individually addressed. Transmission instigation messages reach intermediate communications apparatuses 51, 52 and 53 via transmission paths 62, 63 and 64, and reach dominant nodes 1, 2, 3 . . . 10 via further transmission paths 621, 622, 623 and so on. A dominant node receiving a transmission instigation message sends transmission messages to a tonic node after waiting a predetermined standby time. These transmissions messages may be addressed to any of the tonic nodes. When the dominant nodes 1, 2, 3 . . . 10 have completed their outgoing transmissions, a transmission instigation message is again issued, and the individual dominant nodes caused to perform upstream transmission.

Where the number of upstream transmission messages of the dominant nodes is nonuniform, such methods as discussed above may be employed, including sending transmission instigation messages to specific dominant nodes, increasing the assignment of transmission sequence numbers to specific dominant nodes, or specifying in the transmission instigation messages the count of messages allocated to each dominant node and allowing that amount of transmission.

Downstream Transmission

The foregoing recitation discusses methods of averting collisions in upstream transmissions where multiple tonic nodes are present. The recitation next addresses, with reference to FIG. 19, downstream transmissions from tonic nodes. The simplest method of downstream transmission from a tonic node is to perform downstream transmissions from the individual tonic nodes sequentially. This method consists of the rhythm node conducting transmission instigation of the tonic nodes, as it does of dominant nodes, and performing downstream transmissions sequentially. However, tonic nodes are generally fewer in number than are dominant nodes, and the volume of their downstream transmissions is large. The overhead required for them in transmission instigation is relatively large.

The rhythm node thus allocates downstream transmission permission to tonic nodes sequentially. First, it allocates downstream transmission permission to tonic node 00. The allocation should be of a certain volume—100 packets, for example. When downstream transmissions from tonic node 00 have completed, it is next allocated to tonic node 01 and to tonic node 02. This method of thus allocating transmission permission cyclically is the simplest.

A second method is likewise to that of the above method with respect to its cyclic allocation, but consists of allocating transmission permission until a tonic node runs out of downstream transmission messages. One method to do so is for the rhythm node to monitor whether the tonic node with downstream transmission permission has run out of download transmissions and, when such is confirmed, allocate downstream transmission permission to the next tonic node, and another method to do so is for the tonic node with downstream transmission permission to notify the rhythm node when it has run out of downstream transmission messages and for the rhythm node, upon receipt of this notification, to allocate transmission permission to the next tonic node. However, an upper limit should be placed on the volume of transmission in each round in consideration of such possibilities as an exceptionally large volume of downstream transmission from some given tonic node due to some problem arisen. Further, because transmission instigation messages must be sent from the rhythm node, download transmissions must be controlled so as not to prevent the rhythm node from sending them.

Dedicated Upstream and Downstream Rhythm Nodes

A single rhythm node may handle upstream and downstream operations or, where transmission paths are divided into upstream and downstream transmission paths, an implementation may have two rhythm nodes, one for upstream tasks and one for downstream tasks. Further, because a rhythm node constitutes an important function, a backup rhythm node should be implemented to provide against failure.

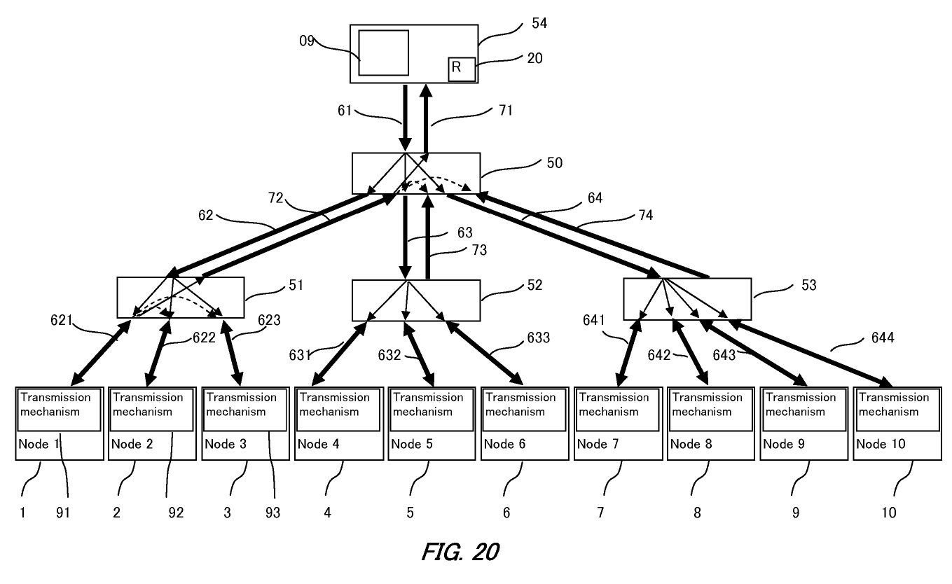

The recitation addresses a particular configuration of tonic nodes and dominant nodes. In FIG. 20, an intermediate communications apparatus 54, a rhythm node 20 and an outgoing-transmission storage apparatus 09 are included. Although this appears to be a configuration comprising solely dominant nodes and a rhythm node, it may be seen that the outgoing-transmission storage apparatus 09 carries out the functions of a tonic node. In FIG. 20, upstream messages from the dominant nodes arrive at the intermediate communications apparatus 54, and messages not addressed to the rhythm node are stored in the outgoing-transmission storage apparatus 09. When an upstream transmission has completed, downstream transmissions are performed from the outgoing-transmission storage apparatus 09. Such a outgoing-transmission storage apparatus is one sort of tonic node.

Transmissions Between Tonic Nodes

The recitation has thus far addressed transmissions between tonic nodes and dominant nodes and transmissions between dominant nodes. Transmissions between tonic nodes are also sometimes required. An example is where an application program is stored across multiple servers and it is run as needed. In such cases, the method may be employed of performing transmissions between tonic nodes by, for example, transmitting messages sent from node 00 in FIG. 19 to transmission path 610 via transmission paths 611 and 612, and nodes 01 and 02 receiving those messages. However, because a tonic node becomes able to perform transmission at the point when it is allocated downstream transmission permission by the rhythm node, this method entails the possibility of delayed transmissions when transmissions are performed from node 00 to node 01 and then from node 01 to node 00.

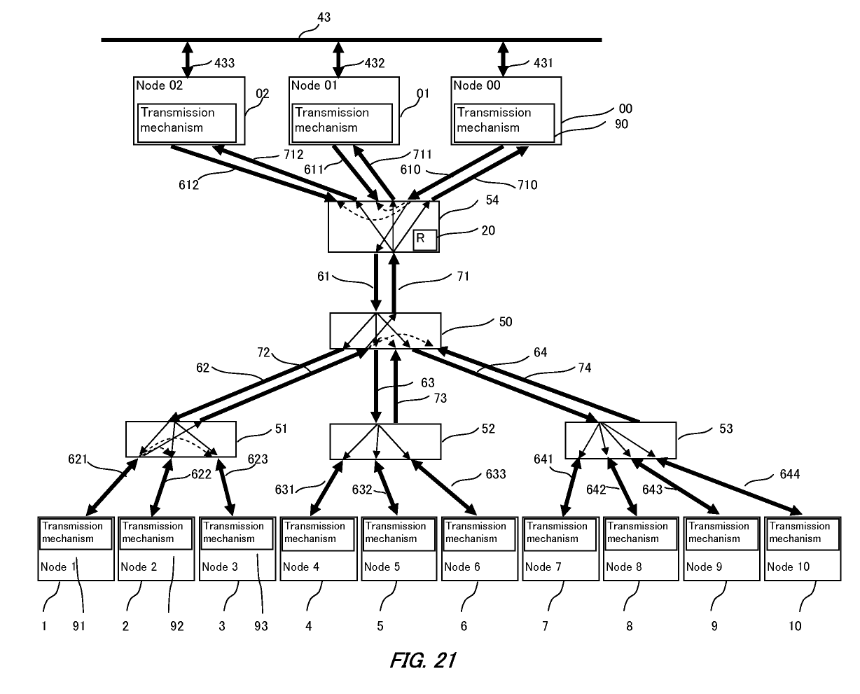

For this reason, in FIG. 21 a transmission path 43 is provided for transmissions between tonic nodes and tonic nodes connected to it by transmission paths 431, 432 and 433. Even where collision-detective transmissions are performed using the transmission path 43, the probability of a collision occurring in transmissions between tonic nodes may be deemed low. Further, because the transmission path 43 is dedicated to transmissions between tonic nodes, there is no possibility of collision with other transmissions. The foregoing recitation applies likewise in discussions of communications networks in which multiple tonic nodes are present. However, transmission paths between tonic nodes are omitted from drawings where they do not particularly pertain to transmission between tonic nodes.

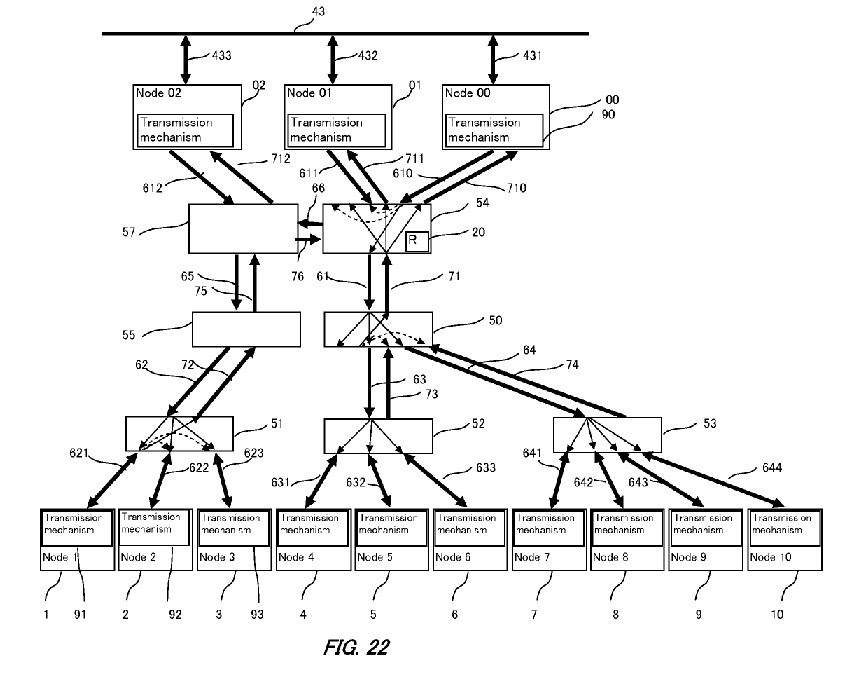

The foregoing discusses multiple tonic nodes connected directly by transmission paths; where the distance between tonic nodes is great and their direct connection is problematic, apparatuses storing transmission messages addressed to tonic nodes may be provided additional to the intermediate communications apparatuses of FIG. 19 and the transmission messages provisionally stored in those transmission message storage apparatuses transmitted to their addressee tonic nodes. In FIG. 21 a single intermediate communications apparatus concentrates all tonic node transmissions, but a configuration is also possible in which, as in FIG. 22, four intermediate communications apparatuses are used, final communications apparatuses are connected to an intermediate communications apparatus 50 or to an intermediate communications apparatus 54, and intermediate communications apparatuses 54 and 55 are connected to transmission paths 66 and 76. Implementation of such a configuration permits alleviation of the load on the intermediate communications apparatuses 50 and 54 in FIG. 21. Utilizing multiple intermediate communications apparatuses in an expansion of this approach enables distribution of the load.

Connections Between Multiple Buildings: Shared Communications Units

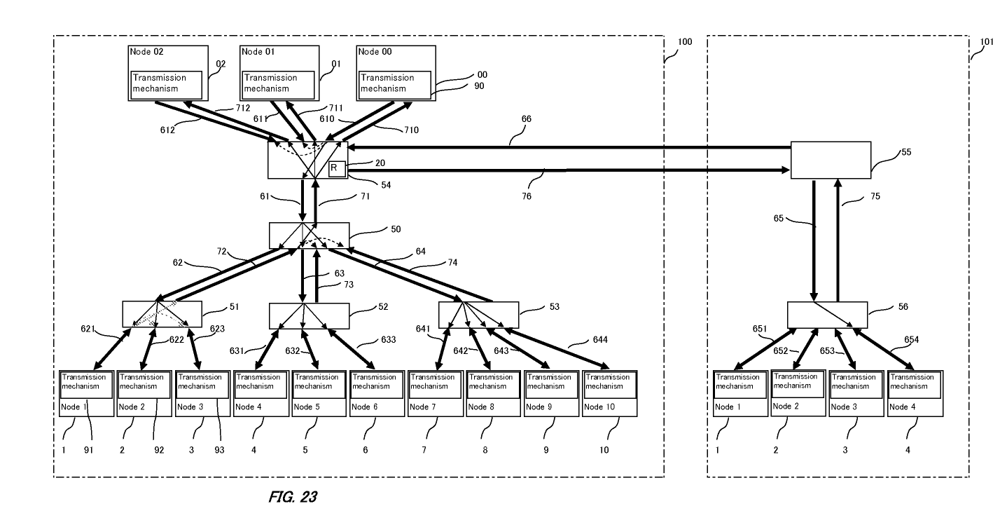

The recitation next addresses transmissions between floors within a large building and transmissions between separated buildings. FIG. 23 is such an example. On the right side of the drawing is a communications network 101 enclosed by a dashed line 101 and comprising an intermediate communications apparatus 55, a final communications apparatus 56 and nodes 11, 12 and 13. On the left side of the drawing is a communications network 100 enclosed by a dashed line 100. These communications networks 100 and 101 are connected by transmission paths 66 and 67. This is an instance of the communications network 100 being, for example, on the first floor of a building and the communications network 101 being on the second floor of the same building. The communications network 101 does not constitute an independent communications unit, rather the whole of FIG. 23 is a single communications unit. Here, a rhythm node 20 is provided to the communications unit and sends transmission instigation messages to all dominant nodes, and upon receipt of those transmission instigation messages by the dominant nodes, upstream transmissions are performed from the dominant nodes after their predetermined standby times. The rhythm node 20 is taken to be housed within an intermediate communications apparatus 54. Here, because nodes 11, 12, 13 and 14 are generally located a long distance from tonic nodes, overall transmission time may be reduced by placing their sequence order towards the end of the transmission cycle. Downstream transmissions are performed by tonic nodes sequentially to the individual dominant nodes.

The foregoing recitation describes the whole of the drawing as a single communications unit, and the foregoing recitation is equally applicable where a final communications apparatus is a multilevel rhythm node having the functions of both a tonic node and a dominant node, or may also be a multilevel rhythm node of three levels or more. An instance of a multilevel rhythm node of three levels or more is, for example, a method in which, where multiple intermediate communications apparatuses are provided in addition to an intermediate communications apparatus 50 and these are connected to multiple final communications apparatuses, the intermediate communications apparatuses and the final communications apparatuses together constitute a communications unit. This applies likewise throughout this specification.

Communications Units of Multiple Levels

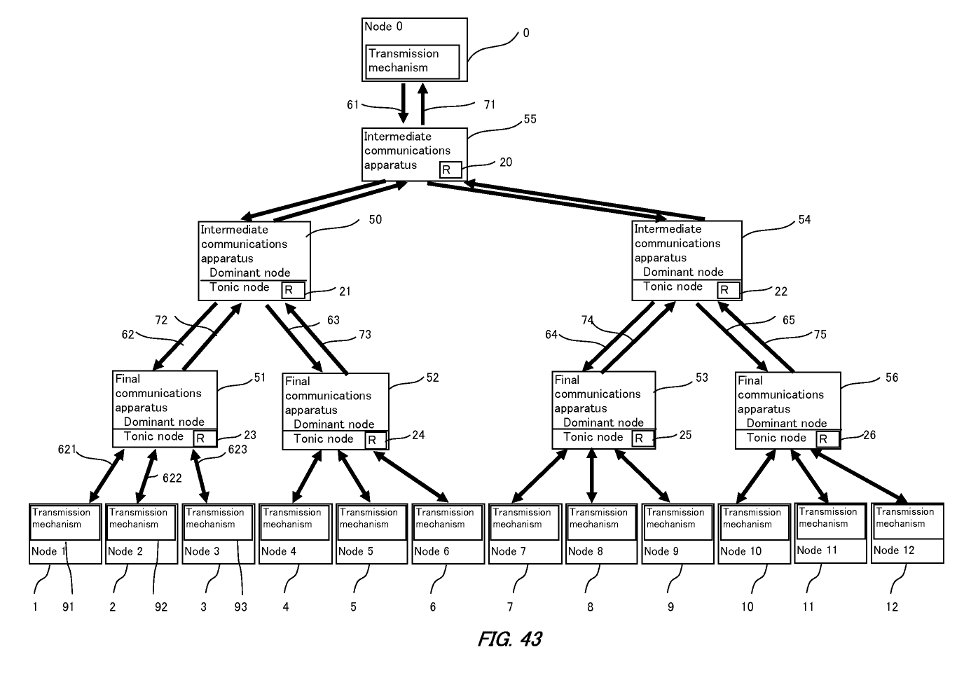

FIG. 43 is an example of multiple levels, as recited above. In FIG. 43, intermediate communications apparatuses 50 and 54 have the functionality of a tonic node and of a dominant node, and also house rhythm nodes. The intermediate communications apparatus 50 and final communications apparatuses 51 and 52 constitute a single communications unit α. Additionally, the intermediate communications apparatus 54 and final communications apparatuses 53 and 56 constitute a single communications unit β. Additionally, an intermediate communications apparatus 55 above them and the intermediate communications apparatuses 50 and 54 constitute a single communications unit γ. The final communications apparatuses 51 and 52 are dominant nodes of the intermediate communications apparatus 50. As seen from the intermediate communications apparatus 50, it is itself a tonic node in this communications unit α, and the final communications apparatuses 51 and 52 that are dominant nodes are connected to it. Upstream transmissions from the final communications apparatuses 51 and 52 are performed upon receiving a transmission instigation message from a rhythm node 21 housed in the intermediate communications apparatus 50. Where upstream transmission data may be reckoned, as here, to be large in volume, the volume of upstream transmissions sent per each transmission instigation message need not necessarily be reckoned one packet at a time, but may be reckoned as a plurality of packets. The intermediate communications apparatus 50 temporarily holds upstream transmission data from the final communications apparatuses 51 and 52. The upstream transmission data thus collected is sent from the intermediate communications apparatus 50 to the intermediate communications apparatus 55 triggered by a transmission instigation message from a rhythm node 20 housed within the intermediate communications apparatus 55. This applies likewise to intermediate communications apparatuses 54, 53 and 56. The foregoing recitation describes rhythm nodes as housed within these communications apparatuses (intermediate communications apparatuses and final communications apparatuses), and the rhythm nodes may also be connected to these communications apparatuses as separate equipment.

Multiple Buildings

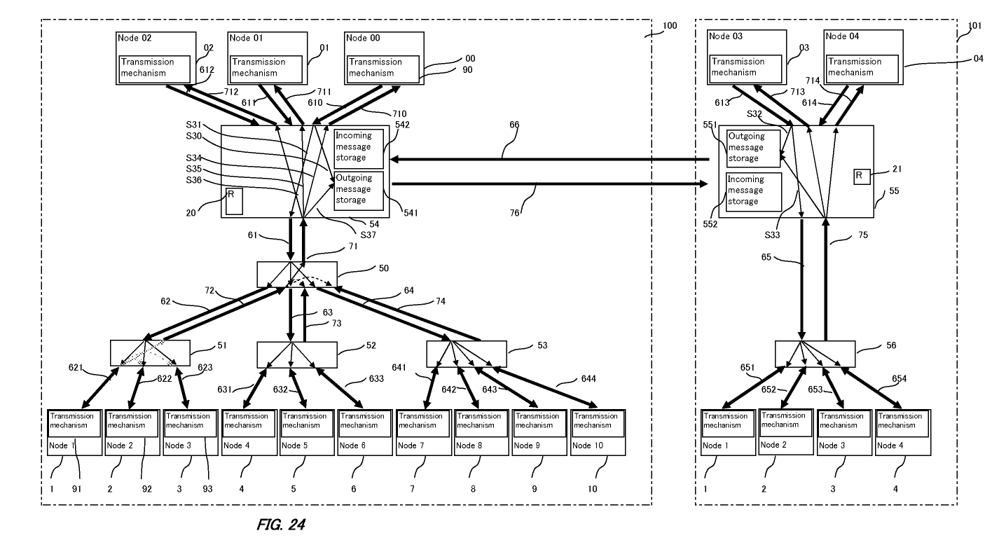

The recitation next addresses the instance of FIG. 24. It is an instance of, for example, multiple buildings. In FIG. 24, a tonic node 03 and a tonic node 04 are connected to the right-hand communications network of FIG. 23. An intermediate communications apparatus 54 and an intermediate communications apparatus 55 are connected by transmission paths 66 and 76. On the left side of the drawing, nodes 00, 01, 02, 1, 2, 3, 4, 5, 6, 7, 8, 9 and 10, intermediate communications apparatuses 50 and 54, and final communications apparatuses 51, 52 and 53 constitute a single communications unit ε (100). Meanwhile, on the right side of the drawing, nodes 03, 04, 11, 12, 13 and 14, the intermediate communications apparatus 55 and a final communications apparatus 56 constitute a single communications unit ζ (101). The communications unit ε and the communications unit ζ each performs transmissions internal to the communications unit by means of the respective rhythm nodes (20 and 21) within each communications unit. The rhythm node 20 is housed within the intermediate communications apparatus 54 and the rhythm node 21 is housed within the intermediate communications apparatus 55. Here the rhythm nodes are described as housed within intermediate communications apparatuses, but the rhythm nodes may also be provided in a configuration with connections external to the intermediate communications apparatuses. The recitation here describes the communications unit ε as a single communications unit and the communications unit ζ as a single communications unit, but as noted in the discussion of FIG. 23, each communications unit may function entirely likewise implemented as a multilevel rhythm node, and may be a multilevel rhythm node of three or more levels.

Transmissions Between Communications Units

Outgoing-Transmission Storage Apparatuses and Incoming-Transmission Storage Apparatuses

Transmissions within communications unit ε and within communications unit ζ may here be performed without difficulty. On the other hand, when dominant node 11, for example, seeks to communicate with tonic node 00 or dominant node 12 seeks to communicate with dominant node 2, it is not possible to perform the transmission because the individual communications units are independent of each other. Transmissions between the individual communications units may be enabled by providing particular equipment to the intermediate communications apparatuses 54 and 55 that connect the communications unit ε and the communications unit ζ. This particular equipment is outgoing-transmission storage apparatuses and incoming-transmission storage apparatuses. FIG. 24 provides an enlarged view of the intermediate communications apparatuses 54 and 55. The intermediate communications apparatuses 54 and 55 contain outgoing-transmission storage apparatuses (541 and 551) and incoming-transmission storage apparatuses (542 and 552). FIG. 24 provides a detailed schematization of the outgoing-transmission storage apparatuses. The recitation examines first the case of the communications unit ζ. In the communications unit ζ, downstream transmission permission is allocated to tonic nodes by a rhythm node 21 of that communications unit, but transmissions from a tonic node 03 or a tonic node 04 to a node belonging to the communications unit ε are sent addressed to an outgoing-transmission storage apparatus 551 in the intermediate communications apparatus 55. FIG. 24 illustrates the performance of a downstream transmission from the tonic node 03. Downstream transmission from the tonic node 03 is performed via a transmission path 613, and those messages subject to outgoing-transmission storage pass along the route S32 and are collected in the outgoing-transmission storage apparatus 551. On the other hand, messages addressed to dominant nodes 11, 12, 13 and 14 pass along the route S33 and are transmitted as downstream transmissions. The primary addressee here is the outgoing-transmission storage apparatus 551, and the secondary addressee the node belonging to the communications unit ε. The outgoing-transmission storage apparatus 551 holds these messages. The recitation here refers to a primary addressee and a secondary addressee, these being logical objects, which may specify only the secondary addressee when specifying an actual address and be sorted by the routing function of the intermediate communications apparatus, or may in fact specify two addressees.

Within the communications unit ε, a rhythm node 20 causes dominant nodes 11, 12, 13 and 14 to perform upstream transmissions by means of transmission instigation messages. Outgoing messages addressed to tonic nodes 00, 01 and 02 are then delivered (S34, 35 and 36) to tonic nodes 00, 01 and 02, but transmissions to nodes belonging to the communications unit ζ are held (S37) by the outgoing-transmission storage apparatus 551. Messages addressed to the communications unit ε in upstream transmissions and downstream transmissions are thus collected in the outgoing-transmission storage apparatus 551. Within communications unit ε, messages addressed to the communications unit ζ are collected by the transmission functionality 541 likewise to operations within the communications unit ε.

Transmissions Between Outgoing-Transmission Storage Apparatuses and Incoming-Transmission Storage Apparatuses

The question next arises of how to transmit the messages collected in the outgoing-transmission storage apparatus 551 to the incoming-transmission storage apparatus 542, and because these transmissions have been collected, they may be forwarded to the intermediate communications apparatuses 54 and 55 by means of a method such as contention without performing such particular transmission as by a rhythm node. Or the outgoing-transmission storage apparatus 551, for example, may send them at the instruction of a rhythm node ε.

Message Distribution from Incoming-Transmission Storage Apparatuses

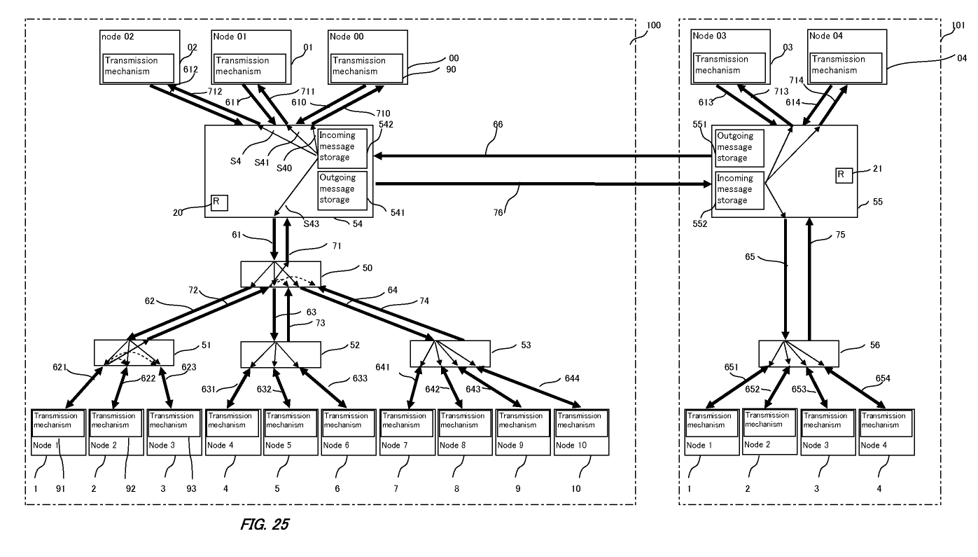

The recitation next addresses, with reference to FIG. 25, how to transmit messages collected in the incoming-transmission storage apparatus 542 to tonic nodes 00, 01 and 02 and to dominant nodes 1, 2, 3 . . . 10. In terms of the configuration of a communications network, FIG. 25 is entirely identical to FIG. 24. The purpose of FIG. 25 is to describe an incoming-transmission storage apparatus. Within the communications ε, upstream transmissions and downstream transmissions are performed in accordance with its rhythm node 20. Upstream transmissions from an incoming-transmission storage apparatus 542 addressed to tonic nodes are then segregated from downstream transmissions addressed to dominant nodes. Upstream transmissions are performed in accordance with transmission instigation, and in doing so, the incoming-transmission storage apparatus 542 sends upstream messages (S40, S41 and S42) addressed to tonic nodes 00, 01 and 02 as a dominant node. On the other hand, the incoming-transmission storage apparatus functions as a single tonic node in downstream transmission. In other words, the tonic nodes 00, 01 and 02 are allocated downstream transmission permission by the rhythm node 20, and the incoming-transmission storage apparatus 542 is included among them. S43 represents a state in which downstream transmission is being performed to a dominant node when an incoming-transmission storage apparatus has been allocated downstream transmission permission as a tonic node. Because upstream transmissions from the incoming-transmission storage apparatus may be large in volume, measures should be taken to cope with nonuniform transmission volumes, such as assigning multiple transmission sequence numbers as a dominant node.

While the foregoing recitation describes transmission from communications unit ζ to communications unit ε, transmission from communications unit ε to communications unit ζ may be performed entirely likewise, reading one for the other inversely in the foregoing recitation. Transmissions may thus be performed without difficulty between nodes belong to communications unit ε and nodes belonging to communications unit ζ. Transmissions may thus be performed between multiple communications units by using outgoing-transmission storage apparatuses and incoming- transmission storage apparatuses.

Implementation of such a configuration permits transmissions at the full transmission capacity of transmission paths even where the distance is great between a communications unit ε and a communications unit ζ, or where the transmission speeds of transmission paths 66 and 76 are lower than those of other transmission paths.

Application of Rhythm Nodes to Outgoing-Transmission Storage Apparatuses and Incoming-Transmission Storage Apparatuses

The foregoing recitation describes transmitting messages between outgoing-transmission storage apparatuses and incoming-transmission storage apparatuses by means of contention or a like method, and methods such as those below are also possible. A first method is not to maintain outgoing-transmission storage apparatuses. This method consists of, given messages from the communications unit ζ to the communications unit ε, for example, transmitting the messages along the transmission path 66 as they arrive, rather than accumulating in the outgoing-transmission storage apparatus downstream transmissions from tonic nodes and upstream transmissions from dominant nodes. This method will result in overflow unless the transmission path 66 is of a speed equal to or greater than that of transmission paths 613, 614 and 75. A second method is to maintain outgoing-transmission storage apparatuses but not to maintain incoming-transmission storage apparatuses. Like the first method, this method consists of, given messages from the communications unit ζ to the communications unit ε, for example, the rhythm node of the communications unit ε transmitting the messages accumulated in the outgoing-transmission storage apparatus 551, separating messages transmitted along the transmission path 66 directly at the intermediate communications apparatus 54 and transmitting them along the several transmission paths. Unless the speed of the transmission path 76 is equal to that of transmission paths 710, 711, 712 and 61, transmission paths in the communications unit ε will fall idle due to the slow arrival of messages from the transmission path 76.

Where an intermediate communications apparatus is provided an outgoing-transmission storage apparatus or an incoming-transmission storage apparatus, the functionality of a tonic node for inter-node transmission may be provided to the outgoing-transmission storage apparatus or the incoming- transmission storage apparatus of the intermediate communications apparatus.

Server Location

Principal servers and like equipment should be located as tonic nodes at the apex of a communications network diagram (for example, FIG. 19). The apex is the terminus of upstream transmissions and the origin of downstream transmissions. The reasons are that this reduces the communications distance with dominant nodes and contributes to communications balance. However, as noted above, the provision of a tonic node for inter-node transmission allows transmissions to be performed with dominant nodes wherever it is located in the communications network. A rhythm node must be located on a communications network where it is capable of multicasting to the requisite dominant nodes.

Addition of Downstream Transmission Paths

Where the volume of downstream transmissions is large, downstream transmission paths may be added such that their capacity is asymmetrical with that of upstream transmission paths.

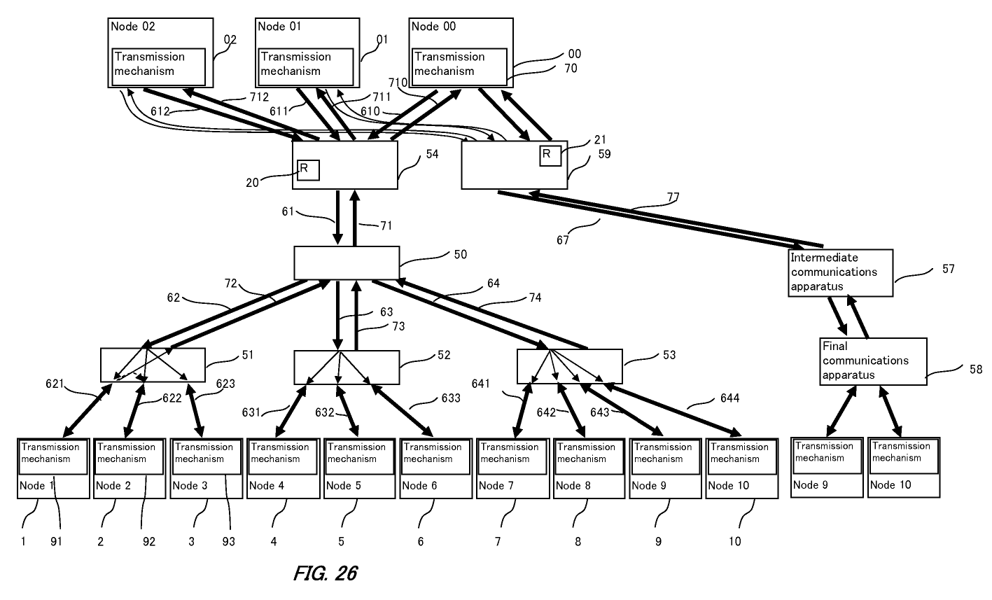

In an implementation of multiple communications units, let a configuration of a communications network, such as that of FIG. 26, having intermediate communications apparatuses 54 and 59 and provided with transmission paths from the intermediate communications apparatus 59 to tonic nodes 00, 01 and 02, be divided into a communications unit η comprising the intermediate communications apparatus 54 and nodes connected to transmission paths 61 and 71, and a communications unit θ comprising the intermediate communications apparatus 59 and nodes connected to transmission paths 67 and 77, each communications unit performing upstream and downstream transmissions independently. In FIG. 26, the transmission paths between the intermediate communications apparatus 59 and tonic nodes 01 and 02 are represented by thin curved lines, this not having any particular significance but being for purposes of viewability and avoiding superposition.

The intermediate communications apparatus 54, for example, in FIG. 19 is provided only the pair of transmission paths 61 and 71 in the direction of downstream transmission, but the communications network configuration permits these to be multiple without difficulty. This applies likewise to other communications network diagrams in the drawings.

Communications Networks in Bus Topologies

The foregoing completes recitation with respect to cascade connection. The recitation next addresses transmission employing a rhythm node where bus transmission paths are in use.

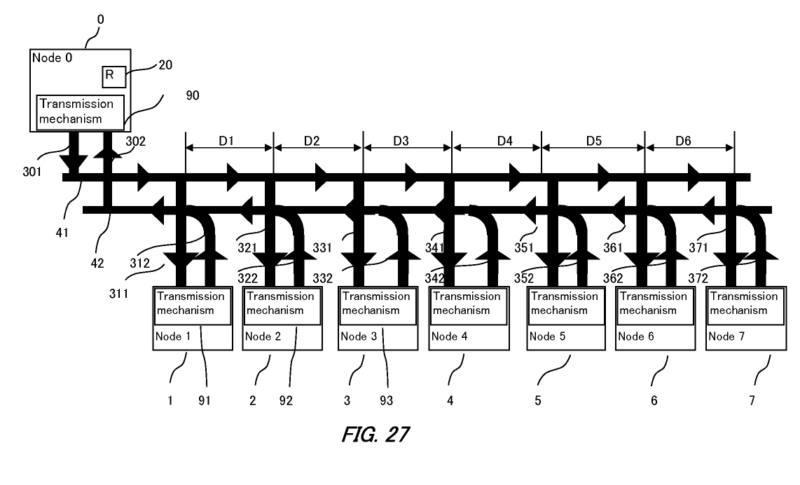

In FIG. 27, nodes 0 through 7 are connected to a transmission path 41. Of these, node 0 has functionality like that of a server for processing large numbers of requests, and nodes 1 through 7 have functionality like that of a client for sending requests to other nodes and receiving the processing results. Node 0 is termed a tonic node, and nodes 1 through 7 termed dominant nodes. Transmissions from the tonic node to a dominant node are termed downstream transmissions, and transmissions from a dominant node to the tonic node termed upstream transmissions. Transmission paths are, as seen from the tonic node 0, comprised of a downstream transmission path 41 and an upstream transmission path 42. This approach is the same as that of full-duplex transmission, as in HDLC.

The following recitation assumes a rhythm node 20 provided in the tonic node 0. The tonic node 0 is connected to the transmission path 41 by a branch transmission path 301 and to the transmission path 42 by a branch transmission path 302. The dominant nodes 1 through 7 are also connected to the transmission path 41 and the transmission 42 by branch transmission paths. The transmission path 42 is a one-way branch path. A one-way branch path has a structure in which, for example, transmission data from dominant node 3 may flow in the direction of tonic node 0, but may not flow in the direction of dominant nodes 4, 5, 6 and 7, or in which transmission data from dominant node 3 may flow towards tonic node 0, but the transmission data may not flow to dominant node 2 or dominant node 1 lying along that transmission path. One-way branching is itself an established method used in communications. By thus employing the methods recited below in addition to the utilization of one-way branching on the upstream transmission path, upstream transmissions from the multiple dominant nodes 1, 2 . . . 7 to the tonic node 0 may be performed without collisions.

Two-way branching is employed for the transmission path 41. A two-way branch path has a structure in which, for example, transmission data from dominant node 3 may flow in the direction of tonic node 0 and may also flow in the direction of dominant nodes 4, 5, 6 and 7, or in which transmission data may flow from dominant node 3 towards tonic node 0, may flow to dominant node 2 or dominant node 1 lying along that transmission path, or may also flow to the other dominant nodes 4, 5, 6 and 7. Transmission data from the tonic node 0 may flow to the dominant nodes 2, 3, 4, 5, 6 and 7.

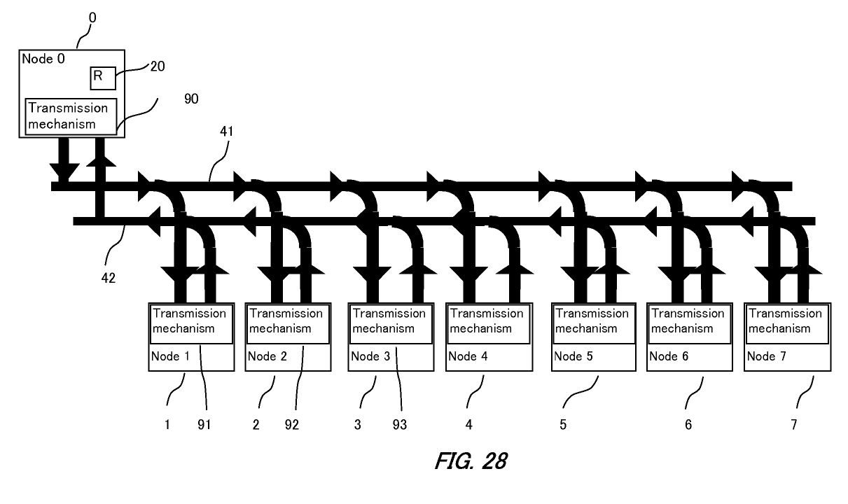

FIG. 28 is an example of one-way branching used for the transmission path 41 as well. Equivalent advantages may be gained whether two-way branching or one-way branching is used for a downstream transmission path.

Collision Aversion by Means of Distance

In FIG. 27 and FIG. 28, the distance D1 between dominant node 1 and dominant node 2 is reckoned equal to the distance D2 between dominant node 2 and dominant node 3 and to the distances D3, D4, D5 and D6 between the other dominant nodes. In general communications, data addressed to one specific node is also transmitted to other nodes along the transmission path. That this data is not processed by non-destination nodes is because data transmitted carries its destination address and nodes ignore data that is not addressed to them. This is effected by transmission mechanisms. Multicasting is also employed for such transmissions to specific nodes. Multicasting allows such transmissions as addressed to all nodes and addressed to each node belonging to a group made up of some number of nodes. As the transmitting node need make but a single transmission rather than transmitting the data to each destination node, the load on the transmitting node and the load on the transmission path may be alleviated.

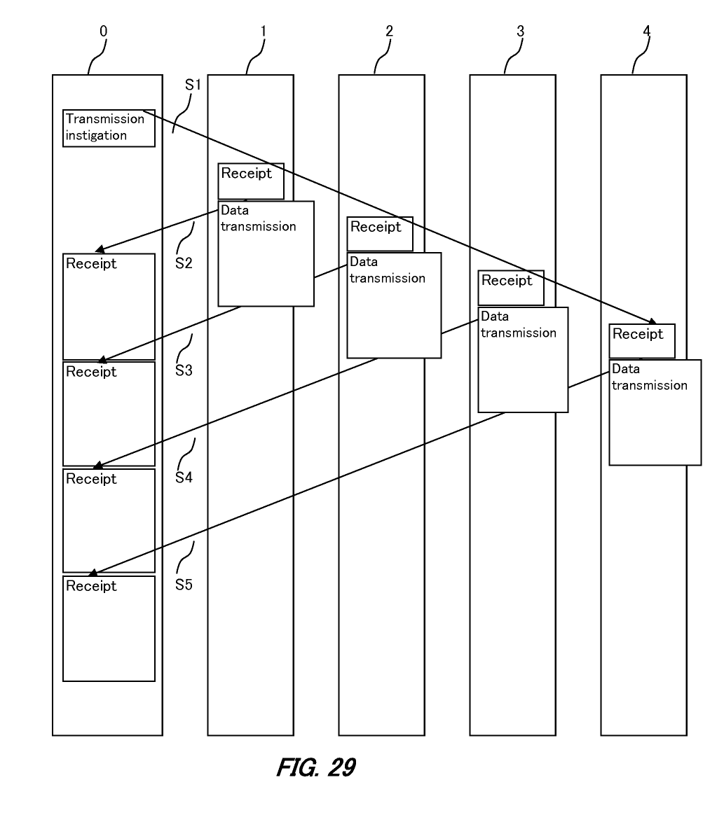

Making reference to FIG. 29, the recitation addresses methods of achieving collision-free transmission. Transmission instigation messages are multicast from a rhythm node 20 (provided in a tonic node 0). If a dominant node receiving a transmission instigation message has data to transmit, it transmits the data immediately. One would expect collisions to occur where individual nodes thus perform transmissions freely, but the following provides a framework in which collisions do not occur. Distances D1, D2 . . . D7 between nodes are all reckoned equal. The time required to transmit 256 bytes on a transmission path having a speed of 10 Gbps is 204.8 ns. Working with 210 ns for the margin, the distance traveled by electricity in 210 ns is 63 meters. In FIG. 29, the rhythm node is multicasting a transmission instigation message. Transmission instigation messages are received by each dominant node with a delay corresponding to the distance from the rhythm node to that dominant node. Each dominant node sends transmission data immediately after receiving a transmission instigation message. The time taken for transmission data to arrive at the tonic node from a dominant node is twice the travel time of an electrical signal over the distance between the tonic node and the dominant node plus the time taken to receive the transmission instigation message. As the time taken to receive the transmission instigation message will be constant for each individual node, no collisions will occur if D1, D2 . . . D7 are at least 31.5 meters apart, even if dominant nodes receiving transmission instigation messages send transmission data immediately after receiving a transmission instigation message.

Thus, upstream data may be made collision-free by sending transmission instigation messages in multicast transmissions from the rhythm node 20 and the individual dominant nodes thus triggered to send transmission data.

Nonuniformity in Upstream Transmissions

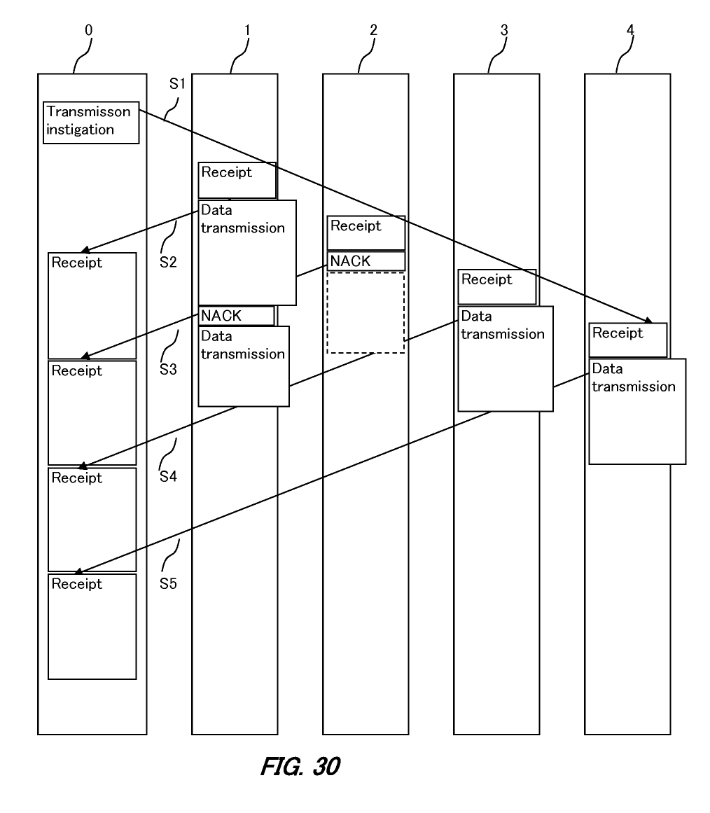

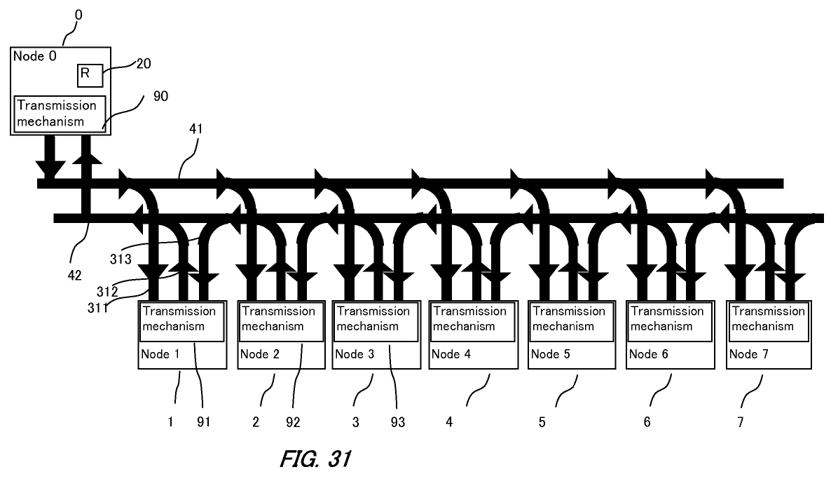

However, although the utilization rate of an upstream transmission path is maximized when transmission data is uniformly present in all dominant nodes, the probability is in fact high that transmission data will be present nonuniformly. In such event, the following will allow efficient transmission of transmission data that is present nonuniformly. The recitation makes reference to FIG. 30 and FIG. 31. A dominant node 2 (2) is reckoned to have no transmission data in response to a transmission instigation message from a rhythm node. The dominant node 2 here returns a NACK. It may be seen in the network diagram of FIG. 31 that branch transmission paths have been added to transmission path 42 to the dominant nodes, relative to the network diagram of FIG. 28. Added to a dominant node 1 is a branch transmission path 313. These branch transmission paths allow their nodes to read upstream transmissions on the transmission path 42.

In FIG. 30, dominant node 2 has transmitted a NACK. A NACK normally consists of one byte of data. Even with the destination and originating addresses included, it will not come to more than 20 bytes or so. Therefore, it is not sent as a 256-byte packet but one of a predetermined length of, say, 64 bytes, and the segment for the message proper is then sent as no signal. This no-signal segment may be used by the dominant node 1 to insert and transmit its own transmission data as a packet shorter than 256 bytes. Due to a delay corresponding to the length of the branch transmission path 313 and the length of a branch transmission path 312, the length of the data that may fit inside the message is shorter by that much. However, the time loss may be minimized by making the branch transmission paths 312 and 313 sufficiently short. On a typical LAN, 7 bytes is used for a preamble, 6 bytes for the MAC address of the destination, 6 bytes for the MAC address of the originator, and the following 64 to 1518 bytes for the data content. Alternatively, the destination address and originator address used in the communications protocol may be included in that following data-content portion. Where the conventions of conventional LANs are observed, conformance with the above lengths is necessary. Where such is implemented, the dominant nodes in FIG. 31 other than dominant node 7 may use the no-signal segment of dominant nodes to their right in the drawing to transmit data additional to their allocation of messages. However, dominant node 7 lacks a dominant node to its right and is therefore unable to use other than its uniform allocation of messages. When dominant node 7 has a large volume of transmission data, therefore, there is a possibility of delay in dominant node 7 processing. Since the transmission data from dominant node 7 will be the last to reach the tonic node 0 in such event, processing delays in the final node may be averted by transmitting multiple messages of a number not more than a predetermined number of messages.

Should the methods described above come into general use, it would also be possible to implement a method of transmitting one or several NACK messages after transmitting multiple messages from the final dominant node and having dominant nodes use those messages prior to the final message.

Collision Aversion by Means of Standby Time

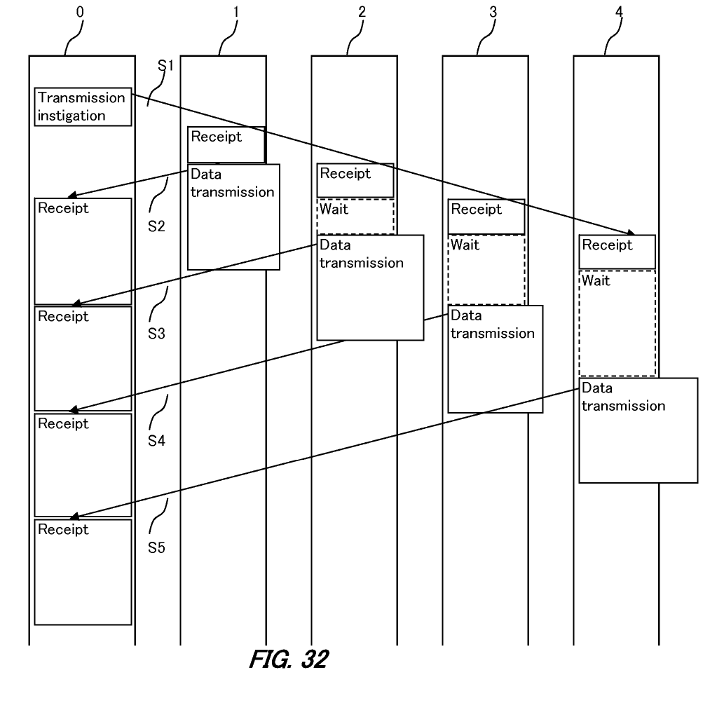

The recitation has addressed instances of individual nodes placed equidistantly. Additionally, that interval is determined by the length of transmission messages and the speed of the transmission path. However, it is sometimes problematic to thus place nodes equidistantly. Additionally, where many nodes are present on a single transmission path, the limit length of the transmission path may be exceeded. Additionally, it becomes problematic to modify the message length given a fixed physical interval. In such instances, collision-free transmissions may be achieved even when decreasing the distance between nodes. The recitation makes reference to FIG. 32. Collisions may be averted by sending transmission data from individual nodes after a fixed interval subsequent to receiving a transmission instigation message from the rhythm node. This consists of treating transmission instigation messages from the rhythm node 0 as a sort of synchronization signal and setting standby time upon receipt of a transmission instigation message.

The standby time is determined by the distance between dominant nodes, message length and the transmission speed of the transmission path. The distance between dominant nodes is expressed as D (meters), message length as L (bytes) and the transmission speed of the transmission path as S (bits per second). Standby time is expressed as T (nanoseconds). The dominant node nearest the tonic node is numbered 1, and the nth dominant node numbered n. The standby time of dominant node n is expressed as Tn (nanoseconds) and is found with Equation K below.

Formula 11
Tₙ=(n−1){(8L/S)−(D/(3×10⁸))} Equation K

This Equation is premised on the dominant nodes being placed equidistantly; where the distance between dominant node 1 and dominant node 2 is expressed as D1, the distance between dominant node 2 and dominant node 3 as D2 and the distance between dominant node Dn and dominant node n+1 as Dn+1, the standby times of these individual nodes may be found with Equation L below.

$$\begin{matrix}Formula 12 & \\ {T}_{n} = ( n - 1 ) \{ ( 8 L / S ) - {\sum }_{m = 1}^{n - 1} {D}_{m} / ( 3 \times {10}^{8} ) \} & Equation L\end{matrix}$$

Thus, collision-free transmission may be performed, even where the interval between dominant nodes is made shorter than the length constraint imposed by message length, by the individual dominant nodes sending transmission data after waiting a predetermined standby time subsequent to receiving a transmission instigation message. Because Equation K and Equation L do not include insertion bits or the length of data required by the format of the message, these conditions are reckoned in L where needed. This applies likewise to equations below.

The foregoing recitation of L and Equation K does not include clock deviation in its calculations; clock deviation may be accounted for by including Equation I, as described with respect to cascade connections.

Nonuniform Upstream Messages

When the count of upstream messages held by individual dominant nodes is nonuniform, such methods may be implemented, as discussed above, as sending transmission instigation messages to specific dominant nodes, increasing the allocation of transmission sequence numbers to specific dominant nodes, or specifying message allocations to individual dominant nodes in transmission instigation messages and allowing transmission of that amount.

Application to Multilevel Implementations

The foregoing recitation addresses a simple bus topology, but the use of intermediate communications apparatuses allows bus-topology communications networks to be plurally connected. In such event, an implementation may also include multiple communications units or a multilevel rhythm node. Additionally, although the recitation has discussed instances of a single tonic node, it applies likewise where there are multiple tonic nodes.

Ring Topologies

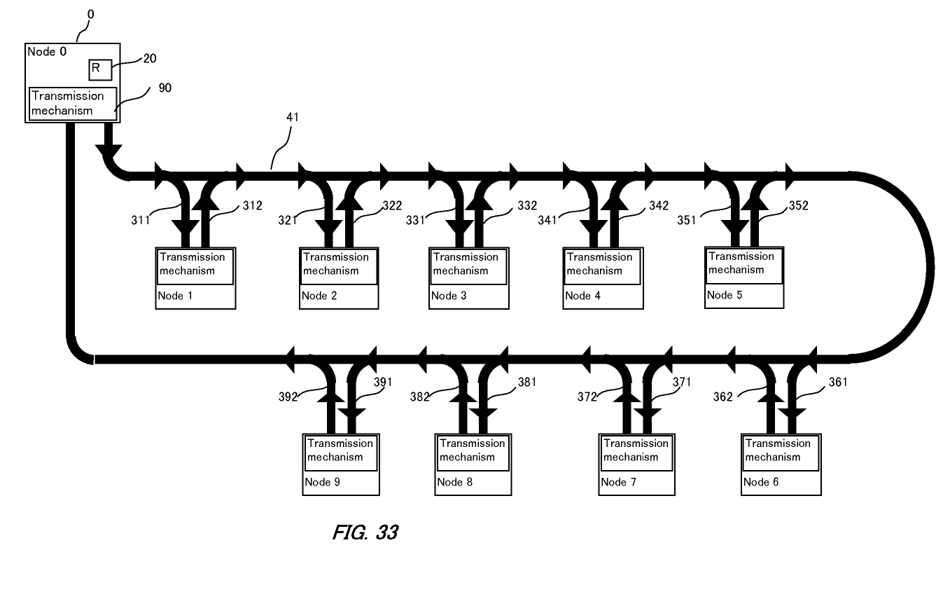

Next, the recitation addresses bus communications networks having a ring topology. FIG. 33 is an example of an implementation of a ring topology. Superficially similar to token-ring networks, where it differs is in the seamless connection of a transmission path 41 with branch transmission paths 311 and 312. This seamless connection of the transmission path 41 resolves the problem of the entire network shutting down when a single node fails, which has been a shortcoming of token ring networks. Transmissions traveling on the transmission path 41 are passed by a tonic node. Here the network is made up of a tonic node 0 and dominant nodes 1, 2, 3 . . . 9. Additionally, because the transmission path has the form of a ring, the transmission path 41 is made up of a single cable. Therefore, upstream transmission and downstream transmission are not segregated on the transmission path 41. For the sake of convenience, transmissions from the tonic node in the direction of the dominant nodes are termed downstream transmissions, and transmissions from the dominant nodes in the direction of the tonic node are termed upstream transmissions, but whether a transmission traveling on the transmission path 41 is an upstream transmission or a downstream transmission depends on its destination. Each of the dominant nodes is connected to the transmission path 41 by such branch transmission paths as 311 and 312. Each branch transmission path is one-way branched, and such branch transmission paths as 311 and 321 are used for receiving downstream transmissions and such branch transmission paths as 312 and 322 used for sending upstream transmissions.

Upstream Transmission

Here, a rhythm node 20 is assumed provided to the tonic node 0. First, in upstream transmission, a transmission instigation message is multicast from the rhythm node 20. After receiving a transmission instigation message, a dominant node waits a standby time predetermined according to the distances between the individual dominant nodes and then sends an upstream message. The predetermined standby time in this instance may be found with Equation J or Equation K, as recited with respect to bus communications networks. In a ring topology, a message addressed to a dominant node need not be an upstream transmission. The tonic node receives messages addressed to itself and retransmits other messages as downstream transmissions on the transmission path. A retransmitted downstream message is one from a dominant node to another dominant node. This is because although a message from dominant node 1 to dominant node 3, for example, will be received by dominant node 3 on a first circuit, a message from dominant node 5 to dominant node 2 will not be received. However, if both a message from dominant node 1 to dominant node 3 and a message from dominant node 5 to dominant node 2 are retransmitted from the tonic node, dominant node 3 will receive a duplicate. In order to prevent such duplicates, serial numbers are assigned when transmission instigation messages are transmitted from the rhythm node. When sending a transmission message from the tonic node downstream on a second circuit, a message denoting it as the second circuit (a recursive message) is inserted at the beginning of the message group, and the serial number from the earlier transmission of the transmission instigation message is attached to that recursive message. A message arriving after having read a transmission instigation message is reckoned to belong to that serial number. As it may thus be recognized from the serial number of a recursive message that a message received on a second circuit is a second message, dominant node 3 will not receive the message. Duplicate reception may thus be averted. Messages received by the tonic node on a second circuit (messages arriving after a recursive message) are all destroyed.

Downstream Transmission

Next, the rhythm node allocates downstream transmission to the tonic node 0. The tonic node 0 then performs downstream transmission. Transmission messages returning to the tonic node in downstream transmission are all destroyed.

Destruction of Messages

The foregoing addresses an instance of a single tonic node; where multiple tonic nodes are present, the rhythm node performs the destruction of transmission messages.

Multilevel Implementation

The foregoing recitation describes the simplest implementation, but an intermediate communications apparatus may also be utilized at the location of the tonic node in FIG. 33 connecting multiple ring communications networks. Such an instance may constitute a single communications unit, or it may constitute multiple communications units. Transmissions may also be performed by placing final communications apparatuses or hub-equivalent equipment at the locations of the dominant nodes in FIG. 33 to connect multiple dominant nodes and appropriately assigning transmission sequence numbers.

Nonuniformity in Upstream Messages

When the count of upstream messages held by individual dominant nodes is nonuniform, such methods may be implemented, as discussed in recitation of cascade connections, as sending transmission instigation messages to specific dominant nodes, increasing the allocation of transmission sequence numbers to specific dominant nodes, or specifying message allocations to individual dominant nodes in transmission instigation messages and allowing transmission of that amount.

Thus, a communications system utilizing a rhythm node may be implemented, regardless of the topology of the communications network.

Modification of Message Length

While the foregoing recitation discusses messages of fixed length, a predetermined message length may, depending on the type of data, be too long or too short. If so, multiple message lengths may be predetermined and each assigned a number. For example, a message length of 16 bytes may be numbered 1, one of 256 bytes numbered 2, and one of 1024 bytes numbered 3. If the rhythm node includes a message-length number in a transmission instigation message when sending the transmission instigation message and modifies the message length of outgoing data from the dominant node depending on that number, there will be fewer empty packets. A method in fact exists of reading the number after reception of a transmission instigation message at a dominant node and modifying the message length to that length. Although this method entails the time required for transmission increasing by the length of the modification time, overall it is only the time corresponding to a single transmission. Another method that may be implemented is to classify according to message length data fitting into the predetermined message lengths and send transmission data in a message length matching the transmission instigation message.

A further method that may be implemented consists of, when sending transmission data from a dominant node, requesting, depending on the size of transmission data held by that dominant node, a message length for use in future transmissions and statistically processing that request at the rhythm node to determine the next message length. This may be implemented by a method of including the message length requested in a portion of a message addressed to a dominant node and the rhythm node reading that message, or by a method of transmitting from a dominant node a short message to the rhythm node after messages to the tonic node.

Methods of Assigning Transmission Sequence Numbers

The foregoing recitation includes no particular discussion of methods of determining transmission sequence from dominant nodes or, in other words, methods of assigning transmission sequence numbers. Dominant nodes nearer the tonic node should be earlier in the transmission sequence and dominant nodes more distant from the tonic node later in the transmission sequence. This is because, if a distant dominant node were early in the sequence, transmission time would grow by the amount of delay deriving from the distance to the distant dominant node. When a distant dominant node is late in the transmission sequence, delays may be prevented by suitably defining its standby time. In addition to a method of determining a fixed transmission sequence number for each dominant node beforehand, another method is to assign the transmission sequence number each time a dominant node boots, as in DHCP. If so, it is additionally possible to reassign a transmission sequence number if transmission times experience problems when the sequence number of a booted dominant node falls later in the sequence.

When a method is implemented of assigning a transmission sequence number each time a dominant node is booted, it may become troublesome to define standby time for each individual dominant node. Dominant nodes should be informed of their standby times by the rhythm node.

Application to Memory Management

Application of the recitation thus far enables application to memory management tables. When individual CPUs operate in a multi-CPU system, they reference and write to a memory management table in order to acquire the memory they require. However, the greater the number of CPUs, the more they compete among themselves for memory, and an increase in the number of CPUs does not allow exercise of capacity commensurate with the number of CPUs. A memory management table itself or an apparatus maintaining the memory management table may be reckoned a tonic node, and each of multiple CPUs reckoned a dominant node. The conventional method has been to let individual CPUs reference and write to the memory management table or the apparatus maintaining the memory management table at their own convenience. As against this approach, collisions in transmission as well as competition for the memory management table may be averted by sending transmission instigation messages from a rhythm node and the individual CPUs sending transmission data in sequence.

Expanding further upon the foregoing, a copy of the memory management table may be maintained in each CPU. When the memory management table undergoes modification, the tonic node multicasts that change. Additionally, the rhythm node does not transmit a transmission instigation message until the individual dominant nodes have applied that modification and transmitted to the tonic node notification that the modification is complete. Each CPU is thus able to reference the most recent state of the memory management table in the portion that it manages itself. After referencing the memory management table, it transmits the requisite request to the tonic server.

Another example where the recitation thus far may be applied is a bus. Conventional busses are capable of bidirectional transmission, as on a LAN, but are appropriated by a single device at any given time in order to avert collisions and have therefore required that much more transmission. As against this, high-speed transmission may be effected by, as seen from a CPU, segregating upstream and downstream transmission paths and multicasting transmission instigation.

Application to Simulation

A further possible application is to simulation. Simulation entails the calculation of multiply divergent eventuations. In such cases, it is advantageous to execute simulations with many CPUs. However, given a context in which numerous calculations are performed on the basis of some given condition, the solution considered most optimal selected, the conditions of the solution selected adopted as further new conditions and numerous calculations performed, such a simulation may be performed by maintaining a conditional expression in multiple dominant nodes, calculating eventuation 1 in a dominant node 1, calculating eventuation 2 in a dominant node 2, and so on. Where the solution calculated in a dominant node 3, for example, is reckoned the most optimal, transmitting that solution and its conditions to a tonic node and transmitting them from the tonic node to each dominant node will result in each dominant node having the same new conditions. Because the transmissions from the tonic node to the dominant nodes have the same content here, it is advantageous to employ multicasting. New calculations on the basis of these new conditions are performed in the individual dominant nodes to give eventuations 11, 12, 13 and so on.

Dynamic Allocation of Upstream Transmission Permission

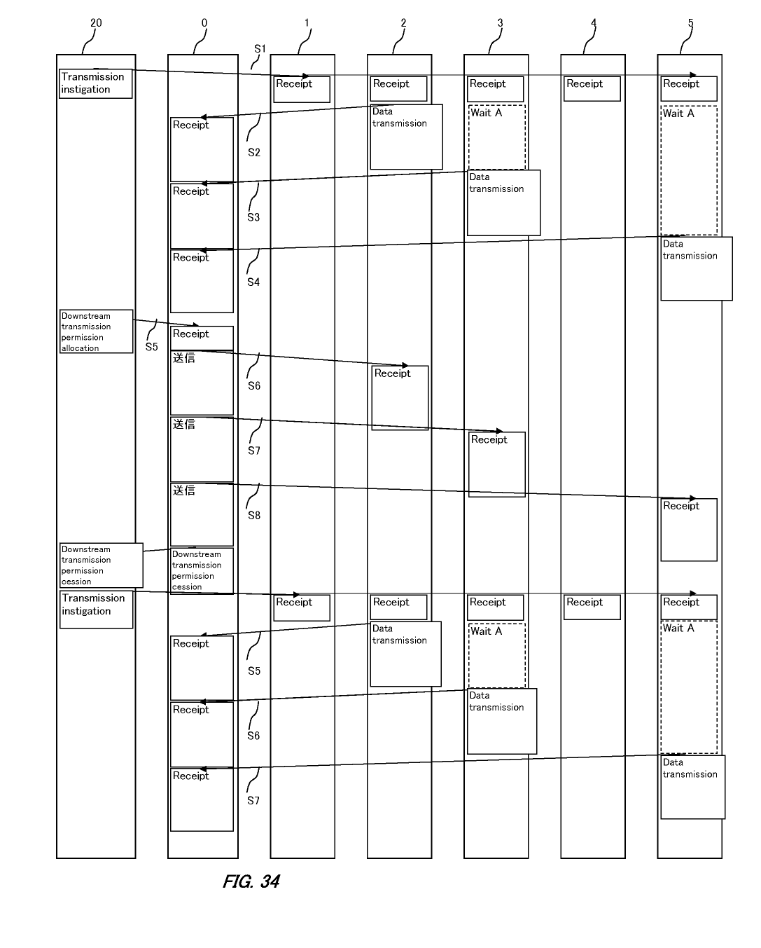

The foregoing recitation has primarily addressed methods of statically allocating upstream transmission permission to dominant nodes that are either connected to a network or running at some given time. Considering some given point in time, however, the number of dominant nodes performing transmissions should not be very large as a proportion of all dominant nodes. In such cases, an effective method of utilizing transmission paths efficiently is to allocate upstream transmission permission dynamically. Reference is made to FIG. 34 in discussing an example of a total of five dominant nodes, of which three dominant nodes perform upstream transmissions at some given time. A transmission instigation message is transmitted (S1) from the rhythm node 20. All dominant nodes receive the transmission instigation message.

In FIG. 34, however, the three dominant nodes with upstream transmission permission are the dominant nodes 2, 3 and 5. Dominant node 1 does not have upstream transmission permission and so does nothing. Given that dominant node 2 has upstream transmission permission and its transmission sequence number is 1, it performs upstream transmission (S2) immediately upon receiving the transmission instigation message. Given that dominant node 3 has upstream transmission permission and its transmission sequence number is 2, it performs upstream transmission (S3) after its predetermined standby time. Dominant node 4 does not have upstream transmission permission and so does nothing. Given that dominant node 5 has upstream transmission permission and its transmission sequence number is 3, it performs upstream transmission (S4) after its predetermined standby time. The rhythm node 20 then allocates (S5) downstream transmission permission to the tonic node. The tonic node 0 performs downstream transmissions (S6, S7 and S8).

Communications in which upstream transmission permission is thus allocated dynamically consist of assigning upstream transmission permission to a dominant node belonging to a communications unit at the time when an upstream transmission is necessary, rather than assigning it upstream transmission permission on a constant basis. A dominant node requiring upstream transmission permission issues an upstream transmission permission request at that time. Where such a method is implemented, the questions arise of how to issue a request for upstream transmission permission, how to allocate upstream transmission permission and what to do when upstream transmission permission is no longer required; these issues may be resolved as follows.

Upstream Transmission Permission Requests

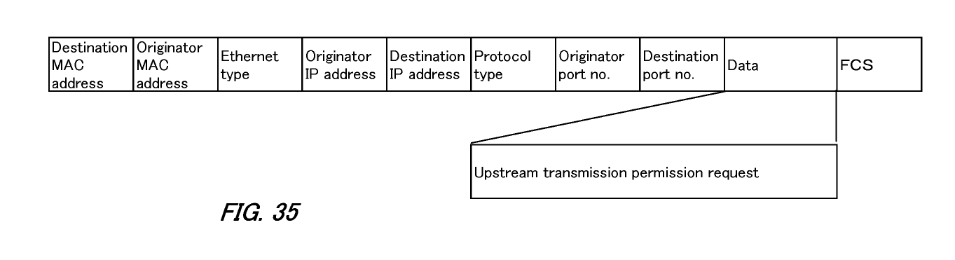

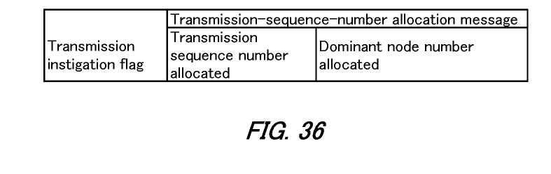

Requests for upstream transmission permission should not be transmitted whenever convenient to the dominant node, as this may bring about transmission collisions. One method of performing upstream transmission permission requests consists of keeping transmission sequence number 1, for example, continuously available and performing upstream transmission corresponding to transmission sequence number 1 when an upstream transmission permission request is generated. In other words, upon receipt of a transmission instigation message, a dominant node requiring upstream transmission permission immediately issues an upstream transmission permission request message to request upstream transmission permission. Upstream transmission permission requests are, of course, made to the rhythm node. FIG. 35 shows an example of the format of the message. The data portion identifies it as an “upstream transmission permission request”. Of course, one to several bytes of data is sufficient here, and it need not employ such language. In response, the rhythm node allocates upstream transmission permission. Allocation of upstream transmission permission is advantageously included in a transmission instigation message. FIG. 36 gives an example of allocation of upstream transmission permission. While the drawing specifies an allocated dominant node number, an IP address or the like may also be used to identify the dominant node. The rhythm node maintains allocation data for upstream transmission permission in an upstream transmission permission allocation data storage region that the rhythm node itself may reference and update.

It is advantageous to provide the upstream transmission permission allocation data storage region internally to the rhythm node, but it may also be present on another system. Allocation data for upstream transmission permission is comprised of data identifying the dominant node and a transmission sequence number.

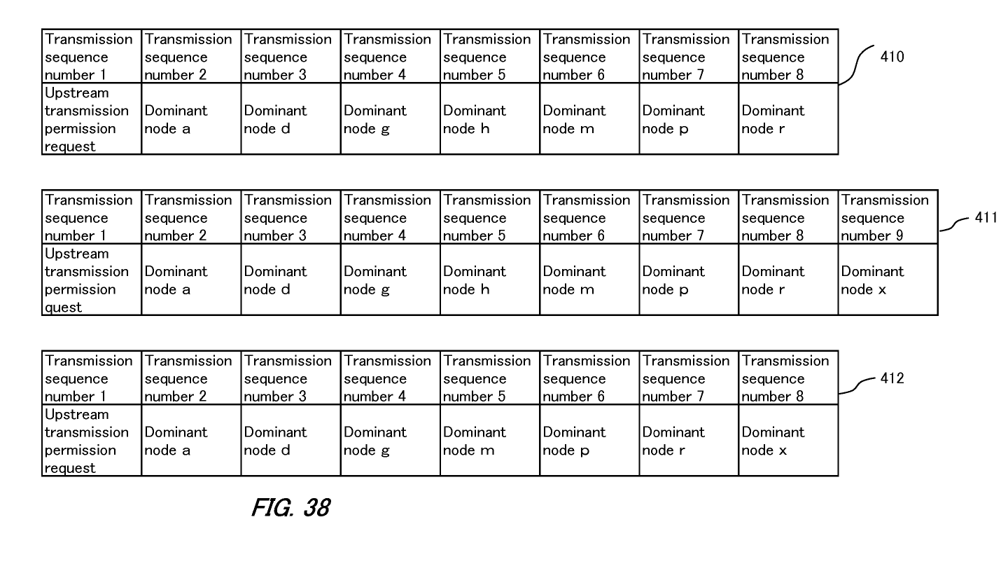

As recited below, FIG. 38 illustrates the transition of upstream transmission permission, using an example of maintaining upstream transmission permission allocation data as a table. In other words, FIG. 38 is an example of maintaining upstream transmission permission allocation data in a table format.

Ceding Upstream Transmission Permission

In order to make efficient use of transmission paths, upstream transmission permission should be returned to the rhythm node immediately upon the completion of upstream transmission. Recalling the common relationship between a client and a server, however, the client first performs upstream transmission. When upstream transmission has completed, the server executes processing and returns a transmission to that client as downstream transmission. Since this consists, in TCP/IP for example, of sending an ACK or NACK with the receipt of each packet, an upstream transmission is generated with the receipt of downstream transmission from a tonic node even when upstream transmission from a dominant node has completed. In such cases, to request upstream transmission permission each time an upstream transmission is generated is, on the contrary, inefficient. One solution to such is to implement a method consisting of the rhythm node monitoring downstream transmissions from tonic nodes and, when a message to some given dominant node contains a finish, canceling the upstream transmission permission allocation addressed to that dominant node.

Another solution is to reply ACK after receipt of a finish from a dominant node and then notify the rhythm node of the cession of upstream transmission permission.

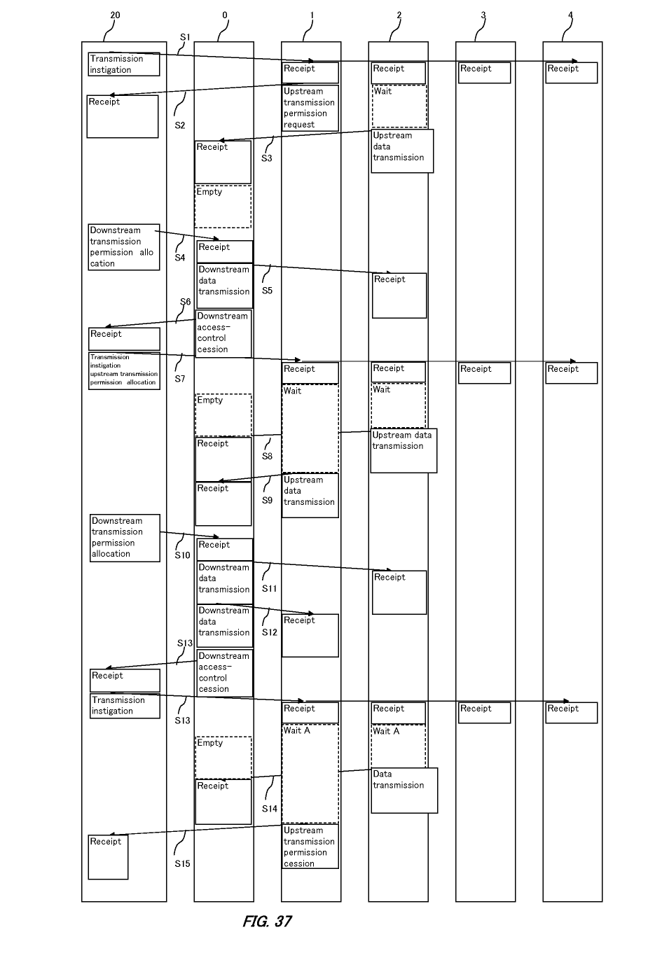

FIG. 37 illustrates the foregoing example. The leftmost column is the rhythm node. The column second from left is the tonic node 0. The columns third from left and subsequent thereto are the dominant nodes 1, 2, 3 and 4. In the drawing, upstream transmission permission is assigned to two dominant nodes, and upstream transmission permission for transmission sequence number 1 is further used to make an upstream transmission permission request.

In other words, the number of dominant nodes assigned upstream transmission permission at one time is fixed at two. In the drawing, only dominant node 2 has upstream transmission permission at the outset. In response to a transmission instigation message S1 from the rhythm node 20, the dominant node 1 uses upstream transmission permission for transmission sequence number 1 to send an upstream transmission permission request S2 to the rhythm node 20. Additionally, the dominant node 2 uses transmission sequence number 2 to perform an upstream transmission S3 after waiting its predetermined standby time. Transmission sequence number 3 is not assigned to any of the dominant nodes. There is therefore open transmission space. Next, the rhythm node 20 allocates (S4) downstream transmission permission to the tonic node 0. The tonic node 0 performs downstream transmission (S5). At this point, it is to the dominant node 2 alone. Next, the tonic node 0 sends (S6) a downstream transmission permission cession message to the rhythm node 20 to cede downstream transmission permission. Next, the rhythm node 20 transmits (S7) a transmission instigation message. This transmission instigation message includes data allocating upstream transmission permission to the dominant node 1. The dominant node 1 is assigned transmission sequence number 3. The dominant node 2 uses transmission sequence number 2 to perform upstream transmission (S8) after waiting its predetermined standby time. The dominant node 1 then performs upstream transmission (S9) for transmission sequence number 3 after waiting its predetermined standby time.

Next, the rhythm node 20 allocates (S10) downstream transmission permission to the tonic node 0. The tonic node 0 performs downstream transmissions (S11 and S12) to the dominant nodes 1 and 2. Next, the tonic node 0 sends (S13) a downstream transmission permission cession message to the rhythm node 20. Next, the rhythm node 20 sends (S14) a transmission instigation message. In response to this transmission instigation message, the dominant node 2 uses transmission sequence number 2 to perform upstream transmission (S14) after waiting its predetermined standby time. The dominant node 1 uses transmission sequence number 3 to transmit (S15) cession of upstream transmission permission after waiting its predetermined standby time. SYN, ACK and like transmissions are omitted in this drawing.

The rhythm node maintains allocation data for downstream transmission permission in an upstream transmission permission allocation data storage region that the rhythm node itself may reference and update. The upstream transmission permission allocation data storage region is advantageously provided internally to the rhythm node, but may exist on another system. Downstream transmission permission allocation data is comprised of data identifying the tonic node and the downstream transmission permission allocation status.

Multiple Allocations of Upstream Transmission Permission

Where sufficient room for upstream transmission is available, multiple allocations of upstream transmission permission to a specific dominant node may be performed in order to prioritize the transmissions of some given dominant node at some given time. While this is not well-suited to protocols, such as BSC and basic TCP/IP, in which the continuous transmission of multiple packets from some given dominant node requires sending an ACK or NACK with the transmission of each packet, it may be employed effectively with such window-driven protocols as TCP/IP, HDLC (High Level Data Link Control) and LAPB (Link Access Procedure, Balanced) that perform continuous data transmissions.

Where the number of upstream transmission permission allocations at some given time is fixed, many dominant nodes seek new allocation of upstream transmission permission and there is little room available for upstream transmission, they should be queued for processing. Additionally, where multiple allocations of upstream transmission permission are made to some given dominant node, as above, requests for their cession may be made from the rhythm node. This method allows the definition of predetermined standby times that accurately reflect the standby time deriving from the length of an individual dominant node's transmission path, but overall efficiency will not be greatly hindered by simplification with predetermined standby times deriving from their maximum length.

Numerical Variabiity of Upstream Transmission Permission Allocations

Fixing the number of upstream transmission permission allocations simplifies control, but the number of upstream transmission permission allocations may be rendered variable in order to perform transmissions efficiently. The recitation makes reference to FIG. 38. Where upstream transmission permission is assigned at some point to seven dominant nodes and one dominant node then immediately requests upstream transmission permission, the following applies. It is assumed that transmission sequence numbers 2 through 8 are allocated to the various dominant nodes performing transmissions and transmission sequence number 1 used for requesting upstream transmission permission. 410 in FIG. 38 illustrates the transmission sequence numbers at this point. The dominant node x requiring upstream transmission permission issues an upstream transmission permission request. Upon receipt of the transmission instigation message immediately subsequent to the necessity for upstream transmission permission arising, that dominant node x immediately uses transmission sequence number 1 to transmit an upstream transmission permission request to the rhythm node. The rhythm node allocates transmission sequence number 9 to that dominant node x. In the next transmission instigation message, it notifies that dominant node x that it has been allocated transmission sequence number 9. FIG. 36 is an example of the format of this transmission instigation message. 411 in FIG. 38 illustrates the transmission instigation message at this point. Upon receipt of this transmission instigation message by that dominant node x, it recognizes its own transmission sequence number and calculates the predetermined standby time. Alternatively, the rhythm node may calculate the predetermined standby time and inform the dominant node. Subsequent to this transmission instigation message, the dominant node x may use transmission sequence number 9 to perform upstream transmissions.

Numerical Variabiity of Upstream Transmission Permission Allocations

When a dominant node to which upstream transmission permission has been allocated cedes upstream transmission permission, the following applies. In the example above, transmission sequence numbers through 9 are in use. It is here assumed that a dominant node h with transmission sequence number 5, for example, has transmitted a cession of upstream transmission permission. The rhythm node then reallocates transmission sequence number 5 to a dominant node m, which had until then been using transmission sequence number 6. Similarly, transmission sequence number 6 is reallocated to a dominant node p, which had been using transmission sequence number 7. Likewise thereafter, such that transmission sequence number 8 is reallocated to the dominant node x, which had been using transmission sequence number 9. The number of dominant nodes having a transmission sequence number at this point is seven. The volume of transmission required for allocating transmission sequence numbers may thus be reduced, if transmission instigation messages are included. When transmission sequence numbers are thus changed, transmissions may be delayed because of the time required for the dominant nodes to immediately modify their predetermined standby times and perform upstream transmissions.

In such event, they may use their pre-existing transmission sequence numbers for upstream transmissions immediately following receipt of a transmission instigation message including a transmission sequence number and use that new transmission sequence number as of receipt of the next transmission instigation message.

Where the number of upstream transmission permission allocations is thus variable, fewer dominant nodes have upstream transmission permission at any given time, and one might expect a relative increase in packets requesting upstream transmission permission. Where one dominant node has upstream transmission permission at some given time, for example, if transmission sequence number 1 is used for upstream transmission permission requests and transmission sequence number 2 for upstream transmissions by that dominant node, the effective utilization rate of upstream transmission permission will be substantively 50%. In order to avoid such an eventuality, the minimum number of upstream transmission permission allocations may be defined as, for example, nine, nine transmission permission allocations and one upstream transmission permission request effected per transmission instigation message and, further, those nine upstream transmission permission allocations made to the same dominant node, thereby giving a 90% effective utilization rate of upstream transmission permission.

Application to Wireless Communications

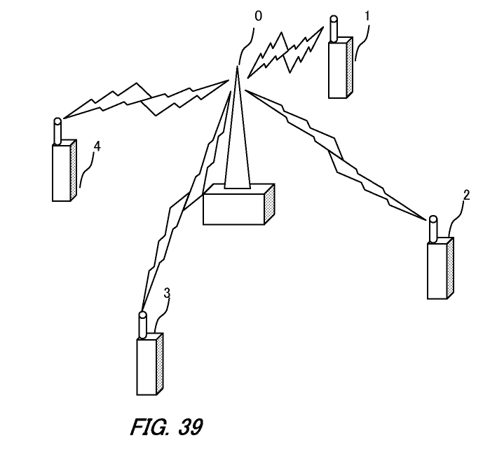

The foregoing recitation addresses implementation with wired transmission paths. The recitation next addresses application to wireless communications. Typical wireless applications include mobile telephony and wireless LANs. Wireless communications consist of communications between a base station and communications devices. Base stations are tonic nodes, and communications devices dominant nodes. FIG. 39 is a schematic drawing of a base station and communications devices. While the detailed description is of an instance of a single base station, the present invention is likewise applicable to instances of multiple base stations, as employed in mobile telephony. Additionally, while it is advantageous in a wireless system to provide the rhythm node in the tonic node, the rhythm node may also be provided separately from the tonic node.

Wireless systems may either split a frequency band and allocate it among communications devices or may communicate with multiple communications devices by means of time-division multiplexing without splitting the frequency band; applications of the embodiments according to this specification employ time-division multiplexing. In wireless communications, communications devices may be located statically or may be located dynamically. Dynamic location refers to either migration of the location of communications devices, or to their variability with respect to the base station. Where locations are thus mobile, fixed distances cannot be allocated. However, in mobile telephony the distance between a base station and a communications device is a maximum of around 5 km. The time required for a signal to travel a distance of 5 km is 16.7 μs. On the other hand, wireless systems have lower transmission speeds than wired systems. Whereas transmission speeds of 1 Gbps and greater have been achieved in wired systems, the maximum for wireless systems is 10 Mbps, and generally around 2 Mbps. This means that it takes longer than on a wired system to send a packet of some given length. Another major difference is that the communications devices are variable with respect to the base station. The number of dominant nodes increases with the initiation of a transmission and decreases with the termination of a transmission. Dominant nodes also appear and disappear as they move about.

The time required to transmit a 256-byte packet at a speed of 2 Mbps is 1024 μs. The time required to transmit a 256-byte packet at a speed of 10 Mbps is 256 μs. Because transmission speeds are low, it does not prove ineffective to implement a method of the difference in distances between dominant nodes and the tonic node varying with standby time. Where the distance traveled of a signal is around 200 meters, as on a wireless LAN in particular, time to arrival is 0.7 μs and presents hardly any difficulty. Given such a method, packets sent from dominant nodes do not reach the tonic node consecutively time-wise, but with gaps in time between them, as on a wired system.

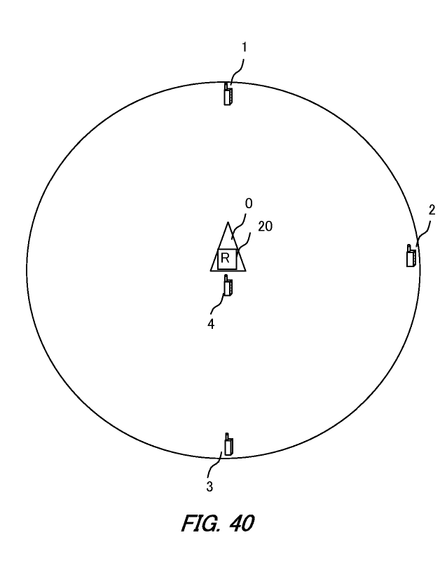

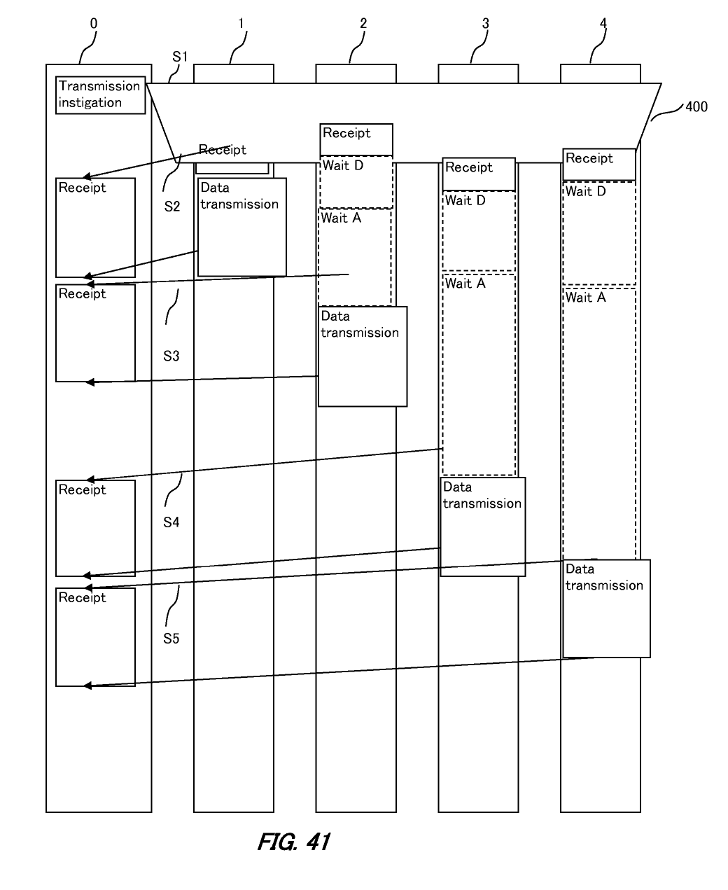

FIG. 40 is a schematic drawing depicting distances between a base station and transmission devices, and their locations, in a wireless system. FIG. 41 is a time chart where the difference in distances between communications devices and a base station varies with standby time (the total time of wait A and wait D). Attention turns here to obtaining wait D. When transmission instigation is multicast from a tonic node 0, dominant nodes 1, 2, 3 and 4 receive it with a transmission delay corresponding to their distance from the tonic node. Here, the description addresses dominant node 2, dominant node 3 and dominant node 4. Dominant nodes 2 and 4 receive transmission instigation from a rhythm node 20 with almost no transmission delay. On the other hand, because dominant node 3 is near the edge of the transmission boundary, it receives the transmission instigation with that amount of transmission delay. Delay time with a dominant node on the transmission boundary from the rhythm node is expressed as Q. When dominant node 3 receives a transmission instigation and performs an upstream transmission after a standby time period accommodating the transmission times of dominant nodes performing upstream transmissions prior thereto, the transmission from dominant node 3 will initiate before upstream transmission from dominant node 2 has completed. The reason is that dominant node 2 receives the transmission instigation later than dominant node 3 by the amount of Q and upstream transmission from dominant node 2 reaches the tonic node 0 with a further delay of Q from the time it is sent from dominant node 2.

The recitation next discusses upstream transmission from dominant node 4 once upstream transmission from dominant node 3 has completed. Taking the point of completion of upstream transmission from dominant node 3 as T1, reception by the tonic node 0 completes simultaneously. However, the signal from dominant node 3 is also passing towards dominant node 4. It arrives at dominant node 4 at a time of Q after T1. In other words, dominant node 4 must initiate transmission by the amount of Q after the completion of transmission from dominant node 3. However, because dominant node 4 receives transmission instigation Q after its transmission from the rhythm node 20, it may also initiate upstream transmission immediately waiting for the time of wait A after reception of the transmission instigation. However, the solution of the recitation is one of applying a predetermined standby time to upstream transmissions from dominant nodes, without performing rigorous measurement of the distance to dominant nodes.

Wait D is a time established to adjust for the difference in distances of dominant nodes from a tonic node and is an integral multiple of twice Q. For dominant node 1 it is zero-fold, for dominant node 2 it is two-fold twice Q (four-fold), for dominant node 3 it is three-fold twice Q (six-fold), and for dominant node 4 it is four-fold twice Q (eight-fold). Where the maximum distance between the rhythm node and a dominant node is 5 km, Q is the one-way transmission time of 16.7 μs.

The recitation makes reference to FIG. 41. The rhythm node 20 is transmitting (S1) transmission instigation. Dominant nodes 1, 2, 3 and 4 are variously receiving the transmission instigation, but since each dominant node is at a different distance from the rhythm node, they receive it with delays corresponding to those distances. Trapezoid 400 represents the time over which transmission instigation is transmitted (i.e. from a distance of 0 to the distance of the signal boundary). When a dominant node receives a transmission instigation, it performs a data transmission after the total standby time of wait D plus wait A.

As described in the recitation with respect to wired systems, wait A is the time provided on the basis of the sequence numbers of individual nodes so as to avert collision with the transmissions of other dominant nodes. As such an instance may be considered likewise to that of transmission instigation arriving at the dominant nodes simultaneously, as where a wired system is implemented with hubs, Formula 5 (Equation E) is applied as discussed with respect to FIG. 5. Dominant nodes 1, 2, 3 and 4 thus perform data transmissions sequentially. The tonic node 0 receives transmission data from each of the dominant nodes, but the timing of their reception diverges somewhat within the range of wait D, rather than packets arriving at regular intervals as on a wired system. In FIG. 40, S2 and S3 are in proximity, but S3 and S4 are removed.

As discussed above, because there is a limit on the number of dominant nodes performing transmissions at any given time on a wireless system in particular, there is considerable waste entailed in allocating upstream transmission permission continually to all eligible dominant nodes. In order to gain transmission efficiencies, an effective method is, as discussed with respect to wired systems, to allocate upstream transmission permission dynamically. In brief, the method consists of a dominant node, when it needs to perform an upstream transmission, transmitting an upstream transmission permission request to the rhythm node and receiving allocation of a transmission sequence number from the rhythm node. Allocation of transmission sequence numbers and cession of upstream transmission permission are likewise to that in wired systems. However, where the minimum transmission speed per dominant node is fixed, as with voice transmissions, an upper limit is placed on the number of upstream transmission permission allocations at any given time and upstream transmission permission allocated so as not to exceed that limit.

Additionally, where few dominant nodes require upstream transmission permission, multiple allocations of upstream transmission permission may be made to a single dominant node. As recited with respect to wired systems, the number of upstream transmission permission allocations should be minimized at any given time so as to employ bandwidth advantageously.

Where different frequency bands are used for upstream and downstream transmissions, full-duplex transmissions may be performed without difficulty from dominant nodes to a tonic node. Where they use the same frequency band, half-duplex bidirectional transmissions may be performed by transmitting transmission instigation and performing downstream transmission from the tonic node after performing upstream transmissions.

Long-Range Wireless Communications

The foregoing recitation addresses such relatively short-range wireless communications as in wireless LANs and mobile telephony, but the principles discussed above may also be applied to communications with aircraft and communications with satellites. As airliners fly at altitudes of around 10 km, their distance from terrestrial base stations is not that great. Given a base station capable of performing transmissions over an area with a radius of some 30 km, the maximum distance between the base station and an aircraft will be some 32 km. As it takes 110 μs for a signal to travel 32 km, the empty time between upstream transmissions may be increased where communications are of high density. Directional antennae should be used so that signals are transmitted only towards the ground in order to avert signal interference between aircraft. Where distance from the earth is several hundred kilometers or several tens of thousands of kilometers, as with satellites, signal travel time over that distance becomes problematic. Given a distance of 300 km, for example, it will take 1 ms for a signal to arrive. Additionally, satellites themselves travel at high speed, some 7.7 km/sec given a circular orbit at an altitude of 300 km.

The recitation below addresses the example of a satellite with a circular orbit at an altitude of 300 km, but is applicable to other cases with predetermined standby time defined according to the conditions obtaining. Where satellite communications are at a 45-degree angle with respect to the perpendicular from a satellite, the distance between the satellite and the base station will range from 300 km to around 430 km. The time required for a signal to travel 430 km is 1.43 ms. As stated above, the time required to transmit a 256-byte packet at a speed of 10 Mbps is 256 μs.

Where the satellite acts as a tonic node internally provided with a rhythm node and the base station acts as a dominant node, the dominant node located perpendicularly beneath the satellite will perform transmission 1 ms after transmission of transmission instigation from the rhythm node. It will be 1 ms later still that the tonic node receives that transmission. The resulting 2 ms of empty time may be reckoned a waste of valuable service availability.

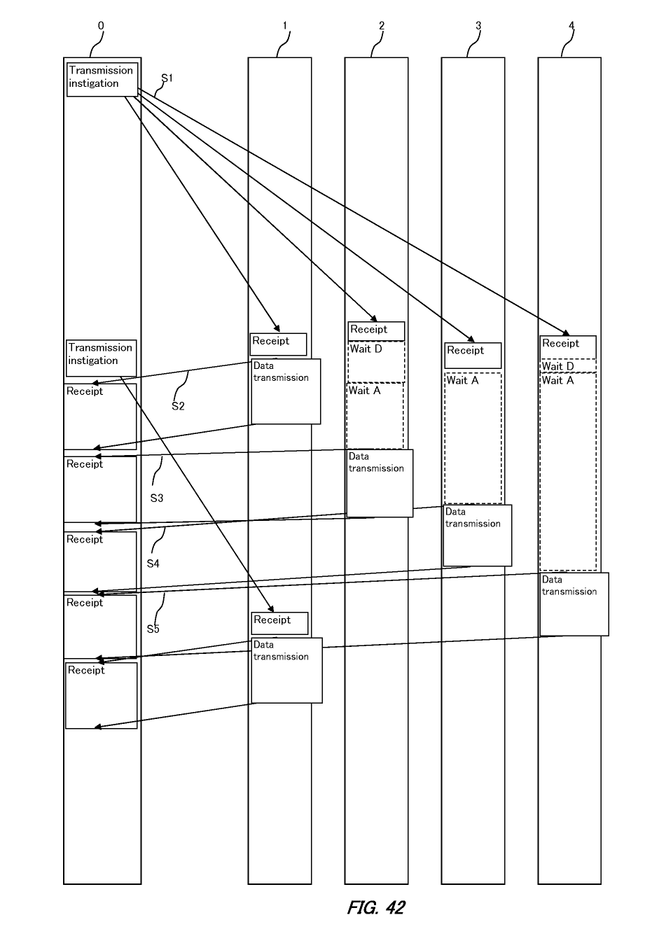

Here, the number of upstream transmission permission allocations and the size of packets in upstream transmissions are determined beforehand. This will determine the total time required for upstream transmissions in a single round of transmission instigation. Given 256 μs per packet, for example, it will take 2.56 ms to transmit a volume of ten packets in one round of transmission instigation. Since no standby time is inserted between packets here, the inclusion of standby time raises this to, provisionally, 3 ms. As shown in FIG. 42, the tonic node receives nothing for a certain period of time after transmission of a first transmission instigation from the rhythm node. A second transmission instigation is transmitted 3 ms later. In FIG. 42, the first transmission instigation is received subsequent to this.

Where the distance between a rhythm node and a dominant node is great, seamless transmission may be performed by thus sending transmission instigation messages at regular intervals, rather than restricting the timing of transmission instigation messages to following the reception of all outgoing data from the dominant node. Signal travel time across the distance between the rhythm node and the dominant node should be measured every several transmissions or every several tens thereof of transmission instigation and the predetermined standby time redefined accordingly. It is thus possible to reduce the empty time between upstream transmissions. The base station should use a directional antenna in order to avert signal interference with other base stations. Transmission sequence numbers should be assigned starting with the dominant node nearest the rhythm node. Transmissions from the dominant node sending first will thus reach the tonic node in the shortest amount of time.

Where, as in satellite communications, the distances between a rhythm node and individual dominant nodes are highly varied and the difference between the greatest distance and the least distance is great, an upstream transmission permission request may not be delivered within the time available, even if transmission sequence number 1 is allocated for upstream transmission permission requests. In such event, the probability of collision may be reduced by using different frequency bands for upstream transmission permission requests and regular upstream transmissions. Additionally, as upstream transmission permission request messages are not large, their frequency band may be of a narrower spectrum than the frequency band for upstream transmissions. The same may be said of where, as in communications over optic fiber, transmissions may be performed simultaneously in multiple frequency bands.

The recitation addressing wired systems focuses on LAN and WAN communications performed within a single organization, and the recitation addressing wireless systems discusses mobile telephony and wide-area wireless systems other than intra-organizational LANs. These frameworks are also applicable to an Internet service provider. Efficiencies in transmission may be obtained both by application of a rhythm node to segments between a terminal and subscribers and by application of a rhythm node likewise between a terminal and a higher-order station.

1-8. (canceled)

9: A communications system, comprising:
a rhythm node that transmits transmission instigation messages, multiple dominant nodes that transmit data upon receipt of a transmission instigation message, multiple tonic nodes that perform downstream transmissions to the dominant nodes, and transmission paths;
in which the rhythm node has functionality for allocating downstream transmission permission to the tonic nodes and multicasts the transmission instigation messages, and the dominant nodes perform upstream transmissions upon receipt of a transmission instigation message and after a predetermined standby time specified individually to each dominant node.

10: The communications system of claim 9, additionally comprising:
segregation of upstream and downstream transmissions, a first rhythm node having functionality for transmitting transmission instigation messages, and a second rhythm node having functionality for allocating downstream transmission permission to the tonic nodes.

11: The communications system of claim 9, additionally comprising:
the rhythm node having functionality for allocating multiple transmission sequence numbers to a specific tonic node.

12: The communications system of claim 9, additionally comprising:
an intermediate communications apparatus that is either one or both of an outgoing-transmission storage apparatus or an incoming-transmission storage apparatus.

13: A communications system, comprising:
multiple communications units, each comprising a rhythm node that transmits transmission instigation messages, multiple dominant nodes that transmit data upon receipt of a transmission instigation message, at least one tonic node that performs downstream transmissions to the dominant nodes, and transmission paths;
in which the multiple communications units are connected hierarchically on multiple levels; and
in which the rhythm node of each communications unit has functionality for allocating downstream transmission permission to the tonic nodes and multicasts transmission instigation messages, and the dominant nodes of each communications unit perform upstream transmissions upon receipt of a transmission instigation message and after a predetermined standby time specified individually to each dominant node.

14: A communications system, comprising:
a rhythm node that transmits transmission instigation messages, multiple dominant nodes that transmit data upon receipt of a transmission instigation message, at least one tonic node that performs downstream transmissions to the dominant nodes, transmission paths, and an upstream transmission-permission allocation data storage region for allocation of upstream transmission sequence numbers to tonic nodes that may be referenced and updated by the rhythm 6 node;
in which the rhythm node multicasts the transmission instigation messages and the dominant nodes perform upstream transmissions after the predetermined standby times specified to them.

15: A communications system, comprising:
a rhythm node that transmits transmission instigation messages, multiple dominant nodes that transmit data upon receipt of a transmission instigation message, at least one tonic node that performs downstream transmissions to the dominant nodes, transmission paths, and a downstream transmission-permission allocation data storage region for allocation of upstream transmission sequence numbers to tonic nodes that may be referenced and updated by the rhythm node;
in which the rhythm node multicasts the transmission instigation messages and the dominant nodes perform upstream transmissions after the predetermined standby times specified to them.

16: The communications system of claim 15, additionally comprising:
the rhythm node having functionality for changing the transmission sequence number of a specific tonic node during transmission.

17: A communications system, comprising:
a rhythm node that transmits transmission instigation messages, multiple dominant nodes that transmit data upon receipt of a transmission instigation message, at least one tonic that performs downstream transmissions to the dominant nodes, and transmission paths;
in which the dominant nodes transmit to the rhythm node data ceding upstream transmission permission when an upstream transmission has completed.
